(19) United States
(12) Patent Application Publication
(10) Pub. No.: US 2023/0306068 A1
(43) Pub. Date: Sep. 28, 2023

(54) RANKING MESSAGES OF A CONVERSATION GRAPH AND DISPLAYING SOCIAL CONTEXT OBJECTS

(71) Applicant: Twitter, Inc., San Francisco, CA (US)

(72) Inventors: Rishabh Misra, Pleasanton, CA (US); Rohit Jain, Seattle, WA (US); Tommy Chong, South San Francisco, CA (US); Vivek Nagubadi, Cheyenne, WY (US)

(21) Appl. No.: 17/805,970

(22) Filed: Jun. 8, 2022

Related U.S. Application Data
(60) Provisional application No. 63/362,556, filed on Apr. 6, 2022.
(60) Provisional application No. 63/267,780, filed on Feb. 9, 2022.

(51) Int. Cl. G06F 16/9538; H04L 51/52; G06F 16/9536

(52) U.S. Cl. CPC G06F 16/9538; G06F 16/9536; H04L 51/52

(57) ABSTRACT

According to an aspect, a method includes receiving, over a network, a conversation view request to retrieve messages from a conversation graph stored on a messaging platform from a first user account, generating a ranked list of messages for at least a portion of the messages from the conversation graph, identifying, from the ranked list of messages, a message authored by a second user account having an indirect relationship to the first user account in an engagement graph, selecting a social context object for the message based on a type of the indirect relationship, and transmitting, over the network, information to display the message and the social context object, the social context object providing information about the type of the indirect relationship.

### CROSS-REFERENCE TO RELATED APPLICATIONS

This application claims priority to U.S. Provisional Application No. 63/267,780, filed on Feb. 9, 2022, and to U.S. Provisional Application No. 63/362,556, filed on Apr. 6, 2022, the disclosures of which are incorporated by reference herein in their entirety.

### BACKGROUND

A social media messaging platform may facilitate the exchange of millions or hundreds of millions of social media messages among its users. The messages posted to the platform often can provide users of the platform the latest update or reporting on current events. The exchange of messages on the messaging platform may be part of a conversation between users. Some conventional messaging systems may store the reply structure of messages so that a user can view parts of the conversation when viewing a particular message. However, the list of messages that form the conversation view may be relatively large, which may lead to slower load times and/or higher request failures.

In some examples, messages retrieved from the conversation graph and served to a user of the platform may include a portion (e.g., a relatively large portion) of messages having “out-of-network” authors, i.e., authors that are not directly connected to the user in a connection graph of the platform. For example, a first user may select a particular message from their timeline, which causes retrieval and display of messages that are replies to that particular message. However, those replies are often from authors that are not directly connected to the first user in a connection graph of the platform.

### SUMMARY

A messaging platform facilitates the exchange of messages between users of the messaging platform. The messages may be part of a conversation occurring on the messaging platform. For example, a user may post a message on the platform, and other users may post a number of replies to that message, and then replies to the replies, and so forth. The reply structure may be stored as a conversation graph, and the messaging platform may store any number of conversation graphs that relate to conversations taking place on the messaging platform. In some examples, the conversation graph may be relatively large (e.g., a number of nodes in the conversation graph exceeding a threshold number). The generation and maintenance of the conversation graphs may enable faster retrieval of information when responding to requests to view messages in a reply relationship with a particular message.

When viewing content on the messaging platform, a user may select a message to view other messages of the conversation graph. In response to the user’s selection, the client application may generate and send a conversation view request to the messaging platform to retrieve messages from the conversation graph. Rather than displaying all of the messages related to the conversation graph (which may be relatively large), the messaging platform may perform a ranking mechanism to rank and select a subset of messages that are provided to the user.

In some examples, the ranking mechanism includes a two-level ranking mechanism in which i) messages of the conversation graph are ranked and the conversation graph is pruned to obtain a candidate subset with higher quality messages and ii) messages of the candidate subset are ranked (e.g., re-ranked) to form a ranked list. In some examples, at least a portion of the ranked list is transmitted to a client application for display. The candidate subset is obtained from the conversation graph by pruning the conversation graph, where the ranking of the candidate subset involves more computer-resource intensive ranking operations using one or more predictive models (e.g., machine-learning models). In other words, the candidate subset includes the remaining messages after the pruning step, and the messaging platform uses one or more predictive models to rank the messages of the candidate subset.

In some examples, the amount of pruning (e.g., how many messages the candidate subset contains) is dependent on a system load factor. For example, if the system load factor is relatively high (e.g., above a threshold level), the messaging platform may prune a higher number of messages (which may result in a lower number of messages within the candidate subset). In some examples, the messaging platform determines the system load factor based on a system load metric (e.g., a latency). The system load metric may be a time interval or duration (e.g., averaged time interval) for processing conversation view requests over a period of time (e.g., the average latency over a 2 or 3 minute window). If the system load metric is relatively high, the messaging platform may increase the number of messages that are pruned from the conversation graph. In some examples, the amount of pruning is dependent on the size of the conversation graph (e.g., the number of messages included within the conversation graph). For example, if the size of the conversation graph is relatively large (e.g., above a threshold level), the messaging platform may increase the number of messages that are pruned from the conversation graph. In some examples, the amount of pruning is dependent on a combination of the system load factor and the size of the conversation graph.

The ranking mechanism implemented by the messaging platform to filter and retrieve messages of a conversation graph may increase the speed of information retrieval, reduce computer resources during high system loads, and/or increase the quality of messages delivered to the client application. For example, the pruning stage may use a ranking algorithm that can remove less-desirable messages (e.g., unwanted messages) earlier in the process, thereby increasing the quality of messages that are selected for the more resource-intensive ranking mechanism. Also, by adjusting the number of messages that are pruned using the system load metric, the speed of information retrieval may be increased during high system loads and the system’s overall reliability may be increased. For example, the messaging platform may be able to handle a higher number of conversation view requests, thereby reducing the number of conversation view requests that may fail.

The first level ranking (e.g., the pruning stage) may include ranking the messages of the conversation graph using a plurality of first signals and selecting, based on the rank, a portion of the messages of the conversation graph as a candidate subset. The first signals may include engagement-based signals, health-based signals, and metadata-based signals to capture higher quality messages from the conversation graph. In some examples, the first signals may include whether or not a message is a deleted message (e.g., a message not marked for deletion may be ranked higher than a message marked for deletion), whether or not an author of a message is a focal author (e.g., a message by the focal author may be ranked higher than other messages), whether or not an author of a message is a root author (e.g., a message by the root author may be ranked higher than other messages), and/or whether or not a message is a message of the viewer (e.g., the one that requested the conversation view request) (e.g., a message by the viewer may be ranked higher than other messages).

In some examples, the first signals include the number of engagement counts with a respective message (e.g., a message with a higher engagement count is ranked higher than a message with a lower engagement count). In some examples, the engagement count includes the number of times that the message has been favoritized, the number of times that the message has been re-shared, and/or the number of times that a reply was received to a respective message.

In some examples, the first signals include health-based signals about the quality of a message of a conversation graph. In some examples, the health-based signals include a toxicity signal that represents a predicted level of toxicity or abusive content. In some examples, the health-based signals include a reporting signal that represents a predicted level of another user (e.g., a target or mentioned user) blocking, muting, or reporting the message. In some examples, the health-based signals include a spam signal that represents a predicted level of another user reporting the message as spam (when the message is created). In some examples, the health-based signals include a reporting signal that represents a predicted level of any user reporting the message. In some examples, the health-based signals are predicted by one or more prediction models and are retrieved during the pruning stage.

The messaging platform may determine the quantity of messages selected for the candidate subset based on a system load factor. In other words, the messaging platform may determine the amount (e.g., percentage) of pruning based on the system load factor. In some examples, the system load factor is computed based on the latency of executing conversation view requests over a period of time. In some examples, the messaging platform may determine the amount (e.g., percentage) of pruning based on a conversation size factor. In some examples, the messaging platform may determine the amount (e.g., percentage) of pruning based on a combination of the system load factor and the conversation size factor.

The messaging platform may define a lower threshold and an upper threshold for the system load factor. If the latency is equal to or less than the lower threshold, the messaging platform may determine a first value (e.g., zero) for the system load factor, which may cause a first percentage (e.g., 32%) of the conversation graph to be pruned. In some examples, if the latency is equal to or less than the lower threshold, the messaging system is operating in a normal mode. If the latency is equal to or higher than the upper threshold, the messaging platform may determine a second value (e.g., one) for the system load factor, which may cause a second percentage (e.g., 55%) of the conversation graph to be pruned. In some examples, if the latency is higher than the upper threshold, the messaging system is operating in a peak system load mode. In some examples, if the latency is a value between the lower threshold and the upper threshold, the messaging platform may compute a value for the system load factor, where the value is between the first value and the second value, which causes a certain percentage of the conversation graph to be pruned (e.g., between the first percentage and the second percentage). For example, the percentage of pruning may increase (e.g., linearly increase) from the lower threshold to the upper threshold. In some examples, if the latency is between the lower threshold and the higher threshold, the system is operating in a high system load mode.

The amount of pruning may be adjusted based on the conversation size factor. For example, the messaging platform may determine the conversation size factor based on the size of the conversation graph. The messaging platform may define a lower threshold and an upper threshold for the conversation size factor. In some examples, if the size of the conversation graph is lower than the lower threshold, the messaging platform may determine the conversation size factor as a first value (e.g., zero). In some examples, if the size of the conversation graph is higher than the upper threshold, the messaging platform may determine the conversation size factor as a second value (e.g., one). In some examples, if the size of the conversation graph is between the lower threshold and the upper threshold, the messaging platform may compute the value of the conversation factor as being between the first value and the second value. In some examples, the messaging platform may determine the amount of pruning based on the conversation size factor and the system load factor.

The messaging platform may select or prune the messages for the candidate subset using the scores from the first level ranking. In some examples, the messaging platform may select a message having the highest score (e.g., highest rank) from a candidate list. The candidate list first includes the direct replies to the focal message (e.g., all the direct replies to the focal message) along with their scores assigned from the first level ranking. The messaging platform may select the highest scoring message to be included in the candidate subset and may add any replies to the selected message in the candidate list. This process continues until the candidate subset has a number of messages that satisfy the pruning factor. For example, if the conversation graph has 100 messages and the pruning rate is 30%, the process continues until the candidate subset has 70 messages. This methodology may ensure that the conversation graph is connected after the pruning step and no message is served without their parent message.

The second level ranking may include ranking the messages of the candidate subset (e.g., the output of the first level ranking) according to a plurality of second signals. The second signals may include one or more signals that are different from one or more of the first signals. In some examples, the number of second signals may be greater than the number of first signals. The second signals may include a wide variety of signals such as data structure-related signals, health-related signals, engagement signals, social graph signals, historical aggregate signals, and/or content-related signals. The number of second signals and the number of different categories of the second signals used in the prediction may improve the accuracy of the model predictions.

In some examples, the messaging platform may use the plurality of second signals to determine predictive outcomes for each message of the candidate subset. The predictive outcomes are user engagement outcomes that are predicted for each message of the candidate subset. The messaging platform may combine the predictive outcomes to form an engagement score for a particular message and the engagement scores are used to rank the messages of the candidate subset.

The predictive outcomes may include a negative engagement probability, a positive engagement probability, and a reciprocal engagement probability. The negative engagement probability indicates a probability value that the user is predicted to negatively view or engage with the message (e.g., the user may find a message abusive). The positive engagement probability indicates a probability value that the user is predicted to positively engage with the message (e.g., like or favoritize a message). The reciprocal engagement probability indicates a probability value that the user is predicted to further develop the conversation graph (e.g., predicted to reply to the message). The incorporation of the reciprocal engagement probability into the predictive outcomes may incentivize more conversations on the platform.

The second level ranking may use predictive models (e.g., neural networks) to predict the engagement outcomes, which may be more computer-resource intensive in terms of memory and computer processing unit (CPU) power than the first level ranking. In some examples, the second level ranking uses more signals (e.g.., substantially more) signals than the first level ranking. In some examples, the messaging platform may select the top ranked messages from the candidate subset, which forms the ranked list. At least a portion of the messages from the ranked list may be delivered to the client application to be displayed.

Providing a ranked list allows the messaging platform to increase the value provided to users while serving fewer responses. For example, the messaging platform may provide a subset of the responses (e.g., top 10, 15, 20, etc. responses) for each request, which may lead to faster computation on the server, faster load times for the user, and substantially without loss (e.g., any loss) of engagement. Further, the messages ranked according to the engagement values may be specific to each user. For example, some messages of the conversation graph may be more relevant to a first user while other messages of the conversation graph may be relevant to a second user. However, the predictive outcomes determined by the messaging platform are tailored to the specific user. In contrast, some conventional approaches use a voting-based mechanism that may provide the same view for each. In addition, because the messaging platform incorporates the reciprocal engagement probability within its scoring algorithm, the messaging platform may incentivize more conversations on the messaging platform.

In some examples, the second level ranking is adjusted using graph engagement signals that indicate whether an author of one or more messages of the candidate subset has an indirect relationship (e.g., a second-order relationship in an engagement graph) to the user that submitted the conversation view request. For example, a first user account may select a particular message, which causes a conversation view request to be generated to retrieve messages from a conversation graph that includes the selected message. In some examples, the messaging platform may increase the ranking of a message (e.g., increase an engagement value) in the conversation graph that is authored by a second user account that has a second-order relationship (e.g., 2-hop relationship) with the first user account. For example, the first user account may be following one or more user accounts (e.g., first relationship) that also favoritized or liked a message included within the conversation graph (e.g., second relationship). The messaging platform may increase the engagement value associated with the message having the second-order relationship so that the message is up-ranked.

In some examples, the messaging platform may determine and select a particular social context object to be rendered on the display that provides information about the indirect relationship when the message is displayed. A social context object can be a user interface (UI) element associated with the message, which indicates a social context of the message with respect to the user. For example, the UI element can include text, one or more icons, images, animations, sounds, colors, etc. associated with the message to indicate the social context of the message with respect to the user. For example, suppose the first user account follows a number of intermediate user accounts and those intermediate user accounts have favoritorized or liked messages authored by the second user account. It is noted that several examples use the terms follow/follows/followings, but other terms may be used to describe a unidirectional (or bidirectional) relationship such as friend, subscribed to, add, etc. If a particular message from the second user account is on the ranked list to be displayed to the first user account, the messaging platform may transmit information to render a social context object that may state “People you [the first user account] follow usually like Tristan’s [the second user account] messages” when the particular message is displayed. However, the type of social context object is dependent upon the type of second-order relationship. For example, if the first user account has favoritized or liked messages posted by intermediate user accounts and the intermediate user accounts have favoritized or liked messages posted by the second user account, the social context object may state “Some accounts you like often like Tristan’s messages.” It is noted that the term favoritized or liked refers to an action where a user has engaged with a message (e.g., selected the message or selected a UI icon) that expresses approval or appreciation of a message and other terms may be used to represent such behavior.

The messaging platform may include a social context engine that obtains graph engagement signals for messages to be rendered as part of a response to a conversation view request. It is noted that the social context engine may be used in conjunction with one or more other components of the messaging platform, e.g., any component that may cause the display of a message where a social context object could be used to explain an underlying second-order relationship between the viewer and the author. A graph engagement signal may be generated based on an engagement graph that stores information about second-order relationships. The graph engagement signal may indicate the type of the second-order relationship and graph engagement data that may include statistical information about the second-order relationship. In some examples, the graph engagement signal includes a relationship score that indicates the strength of the second-order relationship, which may be computed based on the statistical information. The social context engine may use the type of the second-order relationship, the graph engagement data, and/or the relationship score to determine whether to transmit a social context object, and, if so, determine which type of social context object to render.

The social context engine may select a value for a threshold based on the type of second-order relationship and determine to render the social context object for a particular message in response to the relationship score being equal to or greater than the threshold value. Then, the social context engine may determine the information to be rendered in the social context object based on the type of second-order relationship. The social context engine may transmit information to the client application to render the social context object when the corresponding message is displayed on the client application.

According to an aspect, a method for ranking messages of a conversation graph in a messaging platform includes receiving, over a network, a conversation view request to retrieve messages from a conversation graph stored on the messaging platform, obtaining a system load metric associated with the messaging platform, computing a pruning factor based on the system load metric, pruning the conversation graph according to the pruning factor to obtain a candidate subset of messages, ranking the candidate subset of messages to form a ranked list of messages, and transmitting, over the network, information to render at least a portion of the ranked list on a client application.

According to some aspects, the system load metric includes a latency of executing conversation view requests by the messaging platform. The method may include obtaining a size of the conversation graph, wherein computing the pruning factor includes computing the pruning factor based on the size of the conversation graph and the system load metric. The method may include ranking messages of the conversation graph using a plurality of first signals to form an intermediate ranked list, wherein the intermediate ranked list is pruned according to the pruning factor such that lower ranked messages are not included in the candidate subset of messages. The plurality of first signals may include at least one of a toxicity signal, a reporting signal, or a spam signal. The candidate subset of messages are ranked using a plurality of second signals, the plurality of second signals including one or more signals that are different from the plurality of first signals. The method may include computing a first value for a system load factor in response to the system load metric being equal to or less than a lower threshold, computing a second value for the system load factor in response to the system load metric being equal to or greater than an upper threshold, and computing a third value for the system load factor in response to the system load metric being between the lower threshold and the upper threshold, the third value being a value between the first value and the second value, wherein the pruning factor is computed based on the first value, the second value, or the third value for the system load factor. In some examples, ranking the candidate subset includes computing a plurality of predictive outcomes for each message of the candidate subset, computing an engagement value for a respective message based on the plurality of predictive outcomes, and ranking the candidate subset using the engagement values.

According to an aspect, a messaging system includes at least one processor and a non-transitory computer-readable medium storing executable instructions that when executed by the at least one processor cause the at least one processor to obtain a system load metric associated with a messaging platform, compute a pruning factor based on the system load metric, rank messages of a conversation graph using a plurality of first signals to form an intermediate ranked list, prune the intermediate rank list according to the pruning factor to obtain a candidate subset of messages, rank the candidate subset of messages using a plurality of second signals to form a ranked list of messages, and transmit, over a network, information to render at least a portion of the ranked list on a client application.

According to some aspects, the system load metric includes a latency of executing conversation view requests by the messaging platform. The executable instructions include instructions that when executed by the at least one processor cause the at least one processor to compute a system load factor based on the system load metric, obtain a size of the conversation graph, compute a conversation size factor based on the size of the conversation graph, compute the pruning factor based on the system load factor and the conversation size factor. The plurality of first signals include at least one of metadata-based signals, health-related signals, or engagement-based signals. The plurality of second signals include machine-learning (ML) signals configured to be inputted to a predictive model. The executable instructions include instructions that when executed by the at least one processor cause the at least one processor to compute a plurality of predictive outcomes for each message of the candidate subset, compute an engagement value for a respective message based on the plurality of predictive outcomes, and rank the candidate subset using the engagement values.

According to an aspect, a non-transitory computer-readable medium storing executable instructions that when executed by at least one processor causes the at least one processor to execute operations. The operations include obtaining a system load metric associated with a messaging platform and a size of a conversation graph stored on the messaging platform, computing a pruning factor based on the system load metric and the size of the conversation graph, ranking messages of a conversation graph using a plurality of first signals to form an intermediate ranked list, pruning the intermediate rank list according to the pruning factor to obtain a candidate subset of messages, ranking the candidate subset of messages using a plurality of second signals to form a ranked list of messages, and transmitting, over a network, information to render at least a portion of the ranked list on a client application.

In some examples, the system load metric includes a latency of executing conversation view requests by the messaging platform. The operations may further include computing a system load factor based on the system load metric, computing a conversation size factor based on the size of the conversation graph, and computing the pruning factor based on the system load factor and the conversation size factor. The plurality of first signals includes at least one of metadata-based signals, health-related signals, or engagement-based signals. The plurality of second signals has a number of signals greater than the plurality of first signals. The operations further include computing a plurality of predictive outcomes for each message of the candidate subset, computing an engagement value for a respective message based on the plurality of predictive outcomes, and ranking the candidate subset using the engagement values.

According to an aspect, a method includes receiving, over a network from a first user account, a conversation view request to retrieve messages from a conversation graph stored on a messaging platform, generating a ranked list of messages for at least a portion of the messages from the conversation graph, identifying, from the ranked list of messages, a message authored by a second user account having an indirect relationship to the first user account in an engagement graph, selecting a social context object for the message based on a type of the indirect relationship, and transmitting, over the network, information to display the message and the social context object, the social context object providing information about the type of the indirect relationship.

According to some aspects, the engagement graph includes a first engagement edge connected to the first user account and an intermediate user account and a second engagement edge connected to the intermediate user account and the second user account. The method may include determining the type of the indirect relationship based on information about the first engagement edge and information about the second engagement edge. The information about the first engagement edge indicates that the first user account is connected to the intermediate user account in a connection graph of the messaging platform, and the information about the second engagement edge indicates that the intermediate user account has engaged with one or more messages authored by the second user account. The indirect relationship includes a second-order engagement relationship between the first user account and the second user account. The method may include computing a relationship score for a strength of the indirect relationship and determining, in response to the relationship score being greater than a threshold, whether to display the social context object. Computing the relationship score may include determining a first count of first engagement edges between the first user account and a plurality of intermediate user accounts, determining a second count of second engagement edges between the plurality of intermediate user accounts and the second user account, determining a third count of the plurality of intermediate user accounts that are connected to both the first user account and the second user account, and computing the relationship score based on the first count, the second count, and the third count. The method may include selecting a value for the threshold based on the type of indirect relationship. The indirect relationship may be a first indirect relationship, where the method includes identifying a second indirect relationship between the second user account and the first user account and determining that the first indirect relationship has a priority level higher than a priority level of the second indirect relationship based on priority order information, where the social context object is selected based on the type of the first indirect relationship. Generating the ranked list of messages may include computing an engagement value for each of a plurality of messages of the conversation graph and increasing the engagement value in response to a respective message having a user account with an indirect relationship to the first user account in the engagement graph.

According to an aspect, a messaging system includes at least one processor and a non-transitory computer-readable medium storing executable instructions that when executed by the at least one processor cause the at least one processor to receive, over a network from a first user account, a conversation view request to retrieve messages from a conversation graph stored on a messaging platform, generate a ranked list of messages for at least a portion of the messages from the conversation graph, identify, from the ranked list of messages, a message authored by a second user account having an indirect relationship to the first user account in an engagement graph, select a social context object for the message based on a type of the indirect relationship, transmit, over the network, information to display at least a portion of the ranked list of messages on a client application, and transmit, over the network, information to display the social context object along with the message on the client application, the social context object providing information about the type of the indirect relationship.

According to some aspects, the engagement graph includes a first engagement edge connected the first user account and an intermediate user account and a second engagement edge connected to the intermediate user account and the second user account, where the executable instructions include instruction that when executed by the at least one processor cause the at least one processor to determine the type of the indirect relationship based on information about the first engagement edge and information about the second engagement edge. The indirect relationship includes a second-order engagement relationship between the first user account and the second user account. The executable instructions include instructions that when executed by the at least one processor cause the at least one processor to compute a relationship score for a strength of the indirect relationship and determine, in response to the relationship score being greater than a threshold, whether to display the social context object. The executable instructions include instruction that when executed by the at least one processor cause the at least one processor to determine a first count of first engagement edges between the first user account and a plurality of intermediate user accounts, determine a second count of second engagement edges between the plurality of intermediate user accounts and the second user account, determine a third count of the plurality of intermediate user accounts that are connected to both the first user account and the second user account, and compute the relationship score based on the first count, the second count, and the third count. The executable instructions include instructions that when executed by the at least one processor cause the at least one processor to select a value for the threshold based on the type of the indirect relationship. The indirect relationship is a first indirect relationship, where the executable instructions include instruction that when executed by the at least one processor cause the at least one processor to identify a second indirect relationship between the second user account and the first user account and determine that the first indirect relationship has a priority level higher than a priority level of the second indirect relationship based on priority order information, where the social context object is selected based on the type of the first indirect relationship.

According to an aspect, a non-transitory computer-readable medium storing executable instructions that when executed by at least one processor cause the at least one processor to execute operations, the operations including receiving, over a network from a first user account, a conversation view request to retrieve messages from a conversation graph stored on a messaging platform, generating a ranked list of messages for at least a portion of the messages from the conversation graph, identifying, from the ranked list of messages, a message authored by a second user account having an indirect relationship to the first user account in an engagement graph, selecting a social context object for the message based on a type of the indirect relationship, transmitting, over the network, information to display at least a portion of the ranked list of messages on a client application, and transmitting, over the network, information to display the social context object along with the message on the client application, the social context object providing information about the type of the indirect relationship.

According to some aspects, the operations may include computing an engagement value for each of a plurality of messages of the conversation graph and increasing the engagement value in response to a respective message having a user account with an indirect relationship to the first user account in the engagement graph. The operations may include computing a relationship score for a strength of the indirect relationship and determining, in response to the relationship score being greater than a threshold, whether to display the social context object. The operations may include determining a first count of first engagement edges between the first user account and a plurality of intermediate user accounts, determining a second count of second engagement edges between the plurality of intermediate user accounts and the second user account, determining a third count of the plurality of intermediate user accounts that are connected to both the first user account and the second user account, and computing the relationship score based on the first count, the second count, and the third count.

### BRIEF DESCRIPTION OF DRAWINGS

FIG. 1A illustrates a messaging system for ranking messages of conversation graphs using a light ranking manager and a prediction manager according to an aspect.

FIG. 1B illustrates an example of the light ranking manager according to an aspect.

FIG. 1C illustrates examples of health-based signals used by the light ranking manager according to an aspect.

FIG. 1D illustrates an example of the prediction manager according to an aspect.

FIG. 1E illustrates examples of signals used by the prediction manager according to an aspect.

FIG. 1F illustrates a graph relationship engine of the messaging platform configured to generate one or more engagement graphs and use the engagement graph(s) to generate a graph engagement signal according to an aspect.

FIG. 1G illustrates an example of an engagement graph according to an aspect.

FIG. 1H illustrates a prediction manager that uses graph engagement signals to rank messages of a conversation graph according to an aspect.

FIG. 1I illustrates a social context engine for generating a social context object according to an aspect.

FIG. 1J illustrates examples of indirect relations, social context objects, and thresholds according to an aspect.

FIG. 2 illustrates an example of a predictive model as a neural network according to an aspect.

FIG. 3 illustrates a flowchart depicting example operations of the messaging system according to an aspect.

FIG. 4 illustrates a flowchart depicting example operations of the messaging system according to another aspect.

FIG. 5 illustrates an example of a client application displaying a social context object for a message according to an aspect.

### DETAILED DISCLOSURE

For retrieving messages of a conversation graph, the messaging platform may determine how many messages are to be pruned from the conversation graph during a pruning stage based on a system load factor and/or a conversation size factor. The system load factor is computed based on a system load metric (e.g., a latency of executing conversation view requests over a period of time). The conversation size factor is computed based on the size of the conversation graph. In some examples, the messaging platform may determine a certain percentage of the conversation graph to be pruned using the system load factor and/or the conversation size factor. The messaging platform may rank the messages of the conversation graph using first signals, which may include engagement-based signals, health-based signals, and/or metadata-based signals.

The messaging platform may prune the bottom ranked messages to obtain a candidate subset having higher quality messages. The messaging platform may determine an engagement score for each message of the candidate subset based on predictive outcomes for a respective message. For example, the messaging platform may combine a negative engagement probability, a positive engagement probability, and a reciprocal engagement probability to form an engagement value for a respective message. Then, the messaging platform may select and rank the messages of the candidate subset using the engagement values, which forms a ranked list. In response to the conversation view request, the messaging platform may send information to render at least a portion of the messages from the ranked list on a user interface of a client application.

The ranking mechanism implemented by the messaging platform to filter and retrieve messages of a conversation graph may increase the speed of information retrieval, reduce computer resources during high system loads, and/or increase the quality of messages delivered to the client application. For example, the pruning stage may use a ranking algorithm that can remove less-desirable messages (e.g., unwanted messages) earlier in the process, thereby increasing the quality of messages that are selected for the more resource-intensive ranking mechanism. Also, by adjusting the number of messages that are pruned based on a system load metric and/or a size of the conversation graph, the speed of information retrieval may be increased during high system loads and the system’s overall reliability may be increased. The messaging platform may be able to handle a higher number of conversation view requests, thereby reducing the number of conversation view requests that may fail due to long processing delays.

The messaging platform may generate one or more engagement graphs that include or define indirect relationships (e.g., second-order relationships) between user accounts of the messaging platform. In some examples, an engagement graph may define a larger set of relationships between user accounts such as direct relationships (e.g., 1-hop or first order relationships) and different types of indirect relationships such as second-order (or 2-hop) relationships, third-order (or 3-hop) relationships, and/or relationships greater than third-order relationships. In some examples, the techniques discussed herein with respect to displaying social content objects relate to the second-order (or 2-hop) relationships but may also relate to direct connections or more distant indirect relationships. The messaging platform may include a graph relationship engine that uses the engagement graph(s) to identify indirect relationships between user accounts. In some examples, the indirect relationships include second-order relationships or 2-hop graph relationships. If an indirect relationship exists between two user accounts, the graph relationship engine may generate a graph engagement signal that identifies the type of the indirect relationship. In some examples, the graph engagement signal includes a relationship score that indicates the strength of the indirect relationship. In some examples, the graph engagement signal includes graph engagement data that provides one or more statistics about the indirect relationship.

In some examples, the messaging platform may use the graph engagement signals to adjust the ranking of the messages of the conversation graph. A graph engagement signal may indicate that a first user account has an indirect relationship (e.g., a two-order relationship) with a second user account. An indirect relationship may be where the first user account has followed one or more intermediate user accounts and the intermediate user accounts have favoritized or liked messages posted by the second user account. The messaging platform may increase an engagement value (e.g., up rank) a message in the conversation graph that is authored by the second user account (the author) that has an indirect relationship with the first user account (the viewer). In some examples, the messaging platform uses a two-level ranking mechanism, where messages of the conversation graph are first ranked according to a plurality of first signals. Then, a portion of the (first ranked) messages of the conversation graph are second ranked according to a plurality of second signals. In some examples, the plurality of second signals include the graph engagement signals. In some examples, the plurality of first signals include the graph engagement signals.

For a message of a ranked list of messages of a conversation graph to be delivered to a viewer (the first user account), the messaging platform may determine whether to insert a social context object when the message’s author has an indirect relationship with the first user account. For example, the messaging platform may obtain graph engagement signals (e.g., two-hop graph signals) for messages to be rendered as part of a response to a conversation view request. A graph engagement signal may be generated based on an engagement graph that stores information about second-order relationships. The graph engagement signal may indicate the type of the indirect relationship, graph engagement data about one or more statistics about the indirect relationship, and/or a relationship score that indicates the strength of the indirect relationship. The messaging platform may use the type of the indirect relationship, the graph engagement data, and/or the relationship score to determine whether to insert a social context object for a message, and, if so, determine which type of social context object to insert.

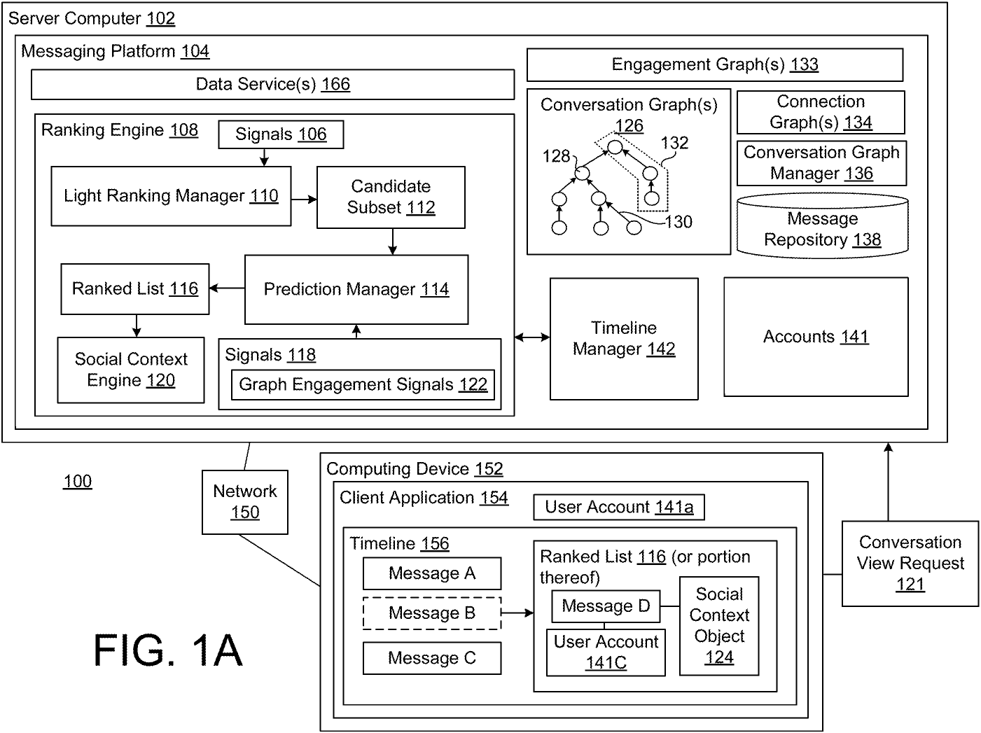

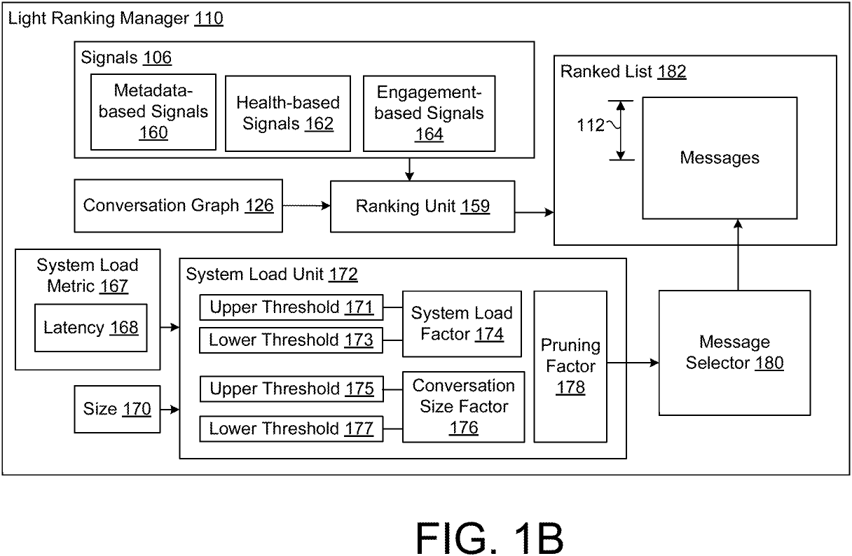

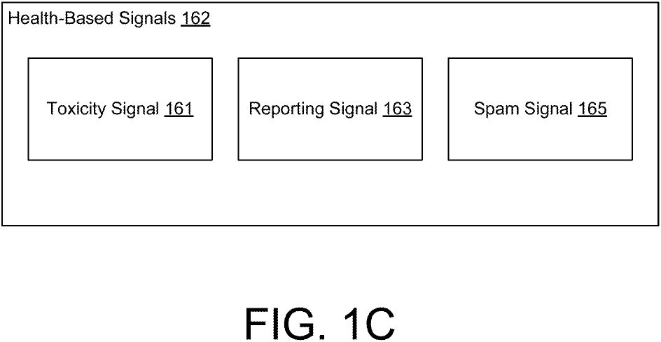

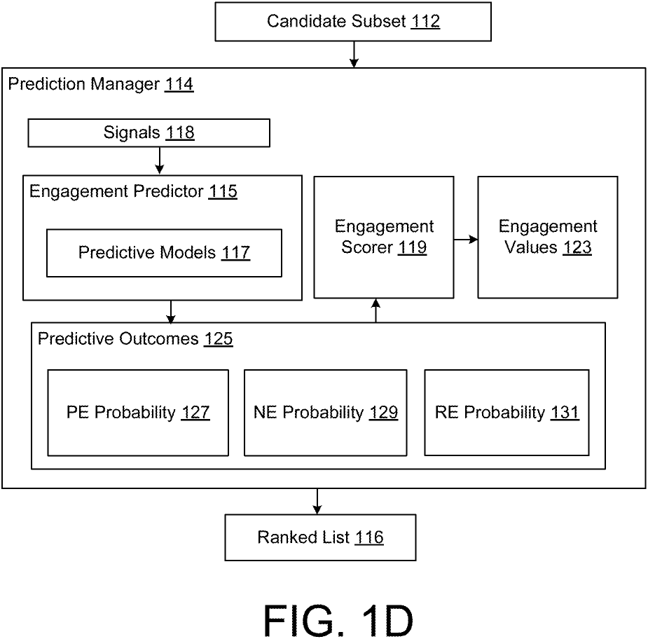

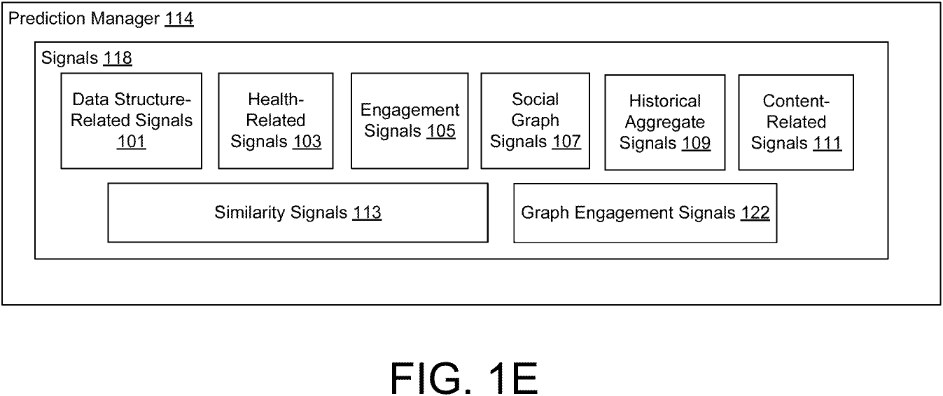

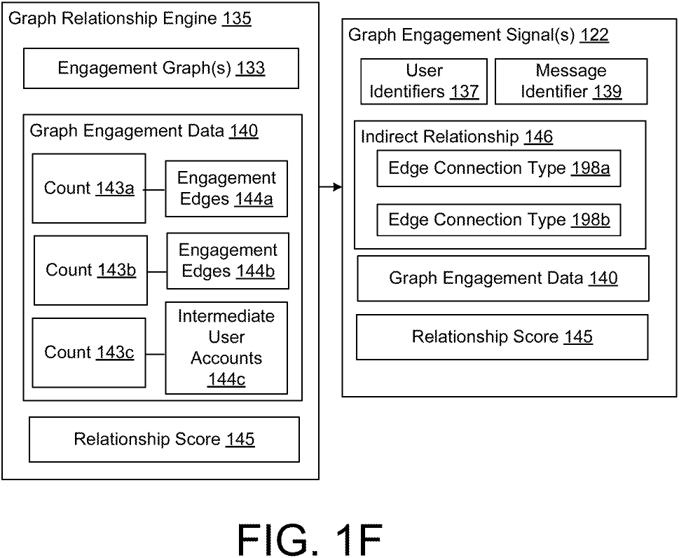

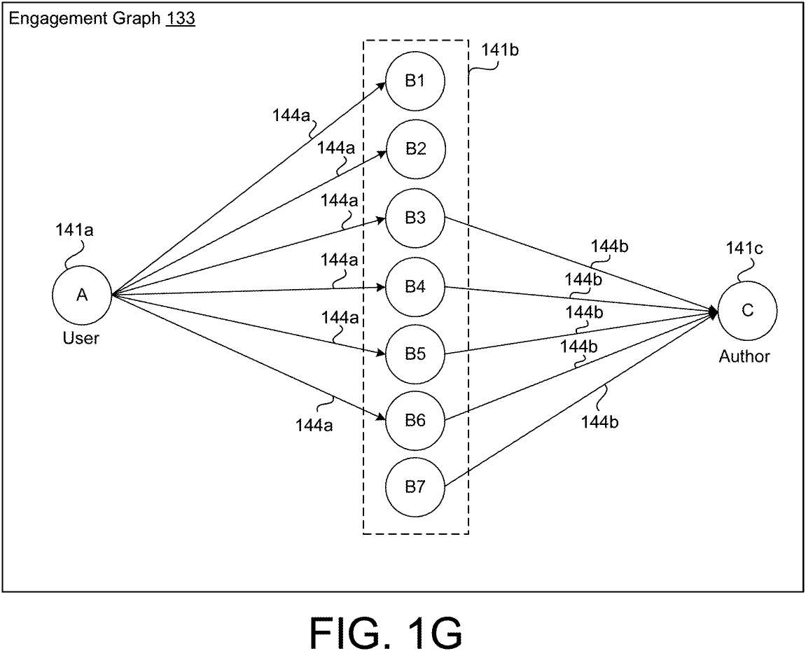

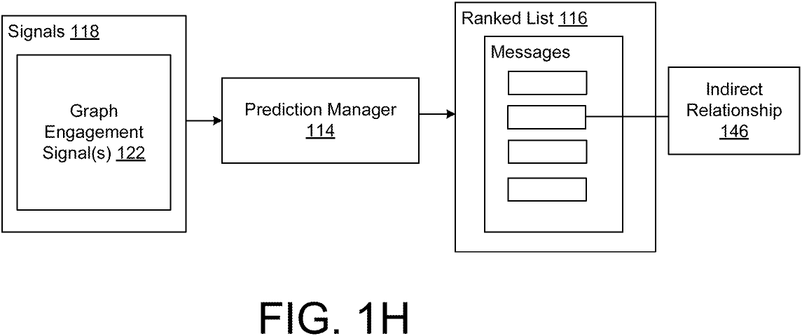

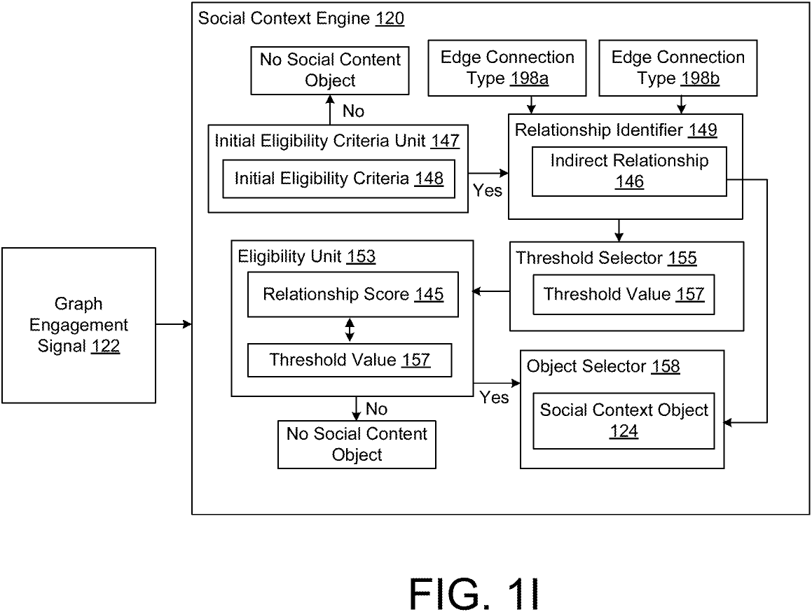

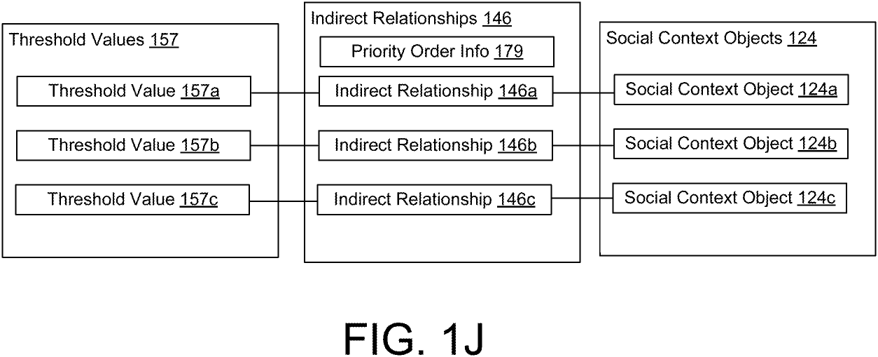

FIGS. 1A through 1J illustrate a messaging system 100 for ranking messages of conversation graphs 126 using a ranking engine 108 according to an aspect. The messaging system 100 includes a messaging platform 104 executable by one or more server computers 102, and a client application 154 executable by a computing device 152 according to an aspect. The client application 154 communicates with the messaging platform 104 to send (and receive) messages, over a network 150, to (and from) other users of the messaging platform 104.

The client application 154 may be a social media messaging application in which users post and interact with messages exchanged on the messaging platform 104. In some examples, the client application 154 is a native application executing on an operating system of the computing device 152 or may be a web-based application executing on the server computer 102 (or other server) in conjunction with a browser-based application of the computing device 152. The computing device 152 may access the messaging platform 104 via the network 150 using any type of network connections and/or application programming interfaces (APIs) in a manner that permits the client application 154 and the messaging platform 104 to communicate with each other.

The computing device 152 may be a mobile computing device (e.g., a smart phone, a PDA, a tablet, or a laptop computer) or a non-mobile computing device (e.g., a desktop computing device). The computing device 152 also includes various network interface circuitry, such as for example, a mobile network interface through which the computing device 152 can communicate with a cellular network, a Wi-Fi network interface with which the computing device 152 can communicate with a Wi-Fi base station, a Bluetooth network interface with which the computing device 152 can communicate with other Bluetooth devices, and/or an Ethernet connection or other wired connection that enables the computing device 152 to access the network 150.

The server computer(s) 102 may be a single computing device or may be a representation of two or more distributed computing devices communicatively connected to share workload and resources. The server computer(s) 102 may include at least one processor and a non-transitory computer-readable medium that stores executable instructions that when executed by the at least one processor cause the at least one processor to perform the operations discussed herein.

The messaging platform 104 is a computing platform for facilitating communication (e.g., real-time communication) between user devices (one of which is shown as computing device 152). The messaging platform 104 may store millions of accounts 141 of individuals, businesses, and/or entities (e.g., pseudonym accounts, novelty accounts, etc.). One or more users of each account 141 may use the messaging platform 104 to send messages to other accounts 141 inside and/or outside of the messaging platform 104. In some examples, the messaging platform 104 may enable users to communicate in “real-time”, e.g., to converse with other users with minimal delay and to conduct a conversation with one or more other users during simultaneous sessions. In other words, the messaging platform 104 may allow a user to broadcast messages and may display the messages to one or more other users within a reasonable time frame (e.g., less than two seconds) to facilitate a live conversation between users. In some examples, recipients of a message may have a predefined graph relationship in a connection graph 134 with an account 141 of the user broadcasting the message.

The connection graph 134 includes a data structure that indicates which accounts 141 in the messaging platform 104 are associated with (e.g., following, friends with, subscribed to, etc.) a particular account 141 and are, therefore, subscribed to receive messages from the particular account 141. For example, the connection graph 134 may link a first account with a second account, which indicates that the first account is in a relationship with the second account. The user of the second account may view messages posted on the messaging platform 104 by the user of the first account (and/or vice versa). The relationships may include unidirectional (e.g., follower/followee) and/or bidirectional (e.g., friendship). The messages can be any of a variety of lengths which may be limited by a specific messaging system or protocol.

Users interested in viewing messages authored by a particular user can choose to follow the particular user. A first user can follow a second user by identifying the second user as a user the first user would like to follow. After the first user has indicated that they would like to follow the second user, the connection graph 134 is updated to reflect the relationship, and the first user will be provided with messages authored by the second user. Users can choose to follow multiple users. Users can also respond to messages and thereby have conversations with one another. In addition, users may engage with messages such as sharing a message with their followers or favoritizing (or “liking”) a message in which the engagement is shared with their followers.

Messages exchanged on the messaging platform 104 are stored in a message repository 138. The message repository 138 may include one or more tables storing records. In some examples, each record corresponds to a separately stored message. For example, a record may identify a message identifier for the message posted to the messaging platform 104, an author identifier (e.g., @tristan) that identifies the author of the message, message content (e.g., text, image, video, and/or URL of web content), one or more participant account identifiers that have been identified in the body of the message, and/or reply information that identifies the parent message to which the message replies (if the message is a reply to a message).

The messaging platform 104 includes a conversation graph manager 136 that generates the conversation graphs 126 and a timeline manager 142 that injects a timeline 156 of messages into the client application 154. The conversation graph manager 136 generates (and updates) one or more conversation graphs 126 as messages are exchanged on the messaging platform 104. In some examples, the conversation graphs 126 are stored in a data storage device associated with the messaging platform 104. In some examples, the conversation graphs 126 are stored at the timeline manager 142. The messaging platform 104 may store multiple conversation graphs 126 (e.g., hundreds, thousands, or millions of conversation graphs 126).

Each conversation graph 126 may represent a structure of replies to an original, non-reply message (e.g., a root message). For example, whenever a user creates and posts an original, non-reply message on the messaging platform 104, a potential new conversation may be started. Others can then reply to that original or “root” message and create their own reply branches. Over time, if the number of replies to the original, non-reply message (and/or replies to the replies to the original, non-reply message) is greater than a threshold level, the conversation graph manager 136 may assign a conversation identifier to the conversation graph 126, and the conversation identifier may uniquely identify the conversation graph 126. In some examples, the conversation graph manager 136 may assign a conversation identifier to each message with a reply. For example, if the messaging platform has message A, and then someone responds to it with a message B, then message A is assigned a conversation identifier that can be used to identify a conversation, which leads to the conversation graph 126 as discussed in detail below. In some examples, if there is a reply to a message, then there is a conversation.

The conversation graph 126 may be a hierarchical data structure representing the messages in a conversation. In some examples, the conversation graph 126 includes a nonlinear or linear data structure. In some examples, the conversation graph 126 includes a tree data structure. The conversation graph 126 may include nodes 128 (or vertices) representing messages and edges 130 (or arcs) representing links between nodes 128. The conversation graph 126 may store the message identifier of the respective message at each node 128. In some examples, the conversation graph 126 stores a user identifier 137 of the author of a respective message at each node 128. The conversation graph 126 may define one or more branches 132 of nodes 128. In some examples, a branch 132 is a portion (e.g., a sub-tree) of the conversation graph 126 that includes one or more nodes 128. In some examples, a branch 132 may be at least two nodes 128 connected by an edge 130, where one of the nodes 128 is a leaf node. In some examples, a branch 132 may be defined as the messages that are connected in a single line (e.g., a leaf message, a first parent message connected to the leaf message, a second parent message connected to the first parent message and so forth until a parent message does not have another parent message).

It is noted that the term “node” may be referred to as a message within the conversation graph 126, or the term “message” may be referred to as a node 128 if that message is included as part of the conversation graph 126. A particular node 128 may be linked to another node 128 via an edge 130, and the direction of the edge 130 identifies the parent message. The nodes 128 may represent a root message, messages in reply to the root message, messages in reply to the messages in reply to the root message, etc.

The conversation graph manager 136 may generate the conversation graph 126 based on a reply structure of the messages. The reply structure may be identified based on metadata associated with each message and/or reply information identified from within the message content. In some examples, the reply structure is identified based on metadata associated with each message which is received from the client application 154 to compose the message. For example, a user may click on a reply link displayed below a message displayed on the user interface of the client application 154. The client application 154 may then display a message composition box for drafting a reply message. The client application 154 may submit metadata including the reply relationship (e.g., a message identifier of the parent message) with the reply message. In some examples, the reply relationship may be explicitly defined by the user within the message content (e.g., identifying a user account 141 (e.g., @tristan) within the body of the message). In this example, the reply structure may be identified by identifying one or more account identifiers and/or message identifiers mentioned within the body of the message.

The timeline manager 142 may send digital information, over the network 150, to enable the client application 154 to render and display a timeline 156 of social content on the user interface of the client application 154. The timeline 156 includes a stream of messages (e.g., message A, message B, message C). In some examples, the stream of messages are arranged in reverse chronological order. In some examples, the stream of messages are arranged in chronological order. In some examples, the timeline 156 is a timeline of social content specific to a particular user (e.g., user account 141a). In some examples, the timeline 156 includes a stream of messages curated (e.g., generated and assembled) by the messaging platform 104. In some examples, the timeline 156 includes a list of messages that resulted from a search on the messaging platform 104. In some examples, the timeline 156 includes a stream of messages posted by users from accounts 141 that are in relationships with the account 141 of the user of the client application 154 (e.g., a stream of messages from accounts 141 that the user has chosen to follow on the messaging platform 104). In some examples, the stream of messages includes promoted messages or messages that have been re-shared.

When viewing the messages on the timeline 156, the user may select one of the messages (e.g., message B) from the timeline 156, which may cause the client application 154 to generate and send a conversation view request 121, over the network 150, to the messaging platform 104. The conversation view request 121 may identify a message identifier of the message that was selected (e.g., message B) and the user identifier (e.g., user account 141a) that is associated with the conversation view request 121. In some examples, the selected message (e.g., message B) may be referred to as a context message or focal message that may serve as an entry point or point of reference within the conversation graph 126. A focal author may be an author of the focal message. The conversation view request 121 may be a request to retrieve messages from the conversation graph 126. In some examples, the conversation view request 121 includes the message identifier of the selected messages and the user identifier of the user of the client application 154. In some examples, the conversation view request 121 also includes the time of the request, which device the user is on, the operating system (OS) version, and/or other metadata associated with the request.

In response to the conversation view request 121, the timeline manager 142 may control the ranking engine 108 to execute the operations discussed herein to retrieve and identify at least a portion of the messages of the conversation graph 126 to be provided to the user. The ranking engine 108 includes a light ranking manager 110 configured to identify a candidate subset 112 from the messages of the conversation graph 126 based on a plurality of signals 106. For example, the light ranking manager 110 may rank the messages of the conversation graph 126 using the signals 106. The light ranking manager 110 may prune the conversation graph 126 to identify the candidate subset 112, where the candidate subset 112 may include higher quality messages from the conversation graph 126.

The light ranking manager 110 may determine how many messages are pruned based on a system load metric 167 (e.g., a latency 168 of executing conversation view requests 121) and/or a size 170 of the conversation graph 126. In some examples, the light ranking manager 110 may determine a pruning factor 178 based on the system load metric 167 and/or the size 170 and prune the conversation graph 126 according to the pruning factor 178. In some examples, the pruning factor 178 includes a pruning percentage such as “prune X%” of the conversation graph 126. The light ranking manager 110 may remove the bottom X% of ranked messages, where the remaining messages are identified as the candidate subset 112.

The ranking engine 108 includes a prediction manager 114 configured to obtain a ranked list 116 of messages of the candidate subset 112 based on a plurality of signals 118. For example, the prediction manager 114 may rank the messages from the candidate subset 112 using the signals 118. The signals 118 may include one or more signals that are different from the signals 118. In some examples, the number of signals 118 used by the prediction manager 114 is greater than the number of signals 118 used by the light ranking manager 110. In some examples, the prediction manager 114 uses one or more neural networks to rank the messages of the candidate subset 112.

In some examples, the signals 118 include one or more graph engagement signals 122, where a graph engagement signal 122 indicates whether an author of a message on the ranked list 116 has an indirect relationship with the user account 141a (e.g., the viewer, the user that submitted the conversation view request 121). The messaging platform 104 may use one or more engagement graphs 133 to determine whether the user account 141a has any indirect relationships with authors of messages that are included on the ranked list 116. An engagement graph 133 may define relationships between user accounts 141 of the messaging platform 104. The relationships between user accounts 141 may be first-order relationships, second-order relationships, third-order relationships, fourth-order relationships, and/or higher-level relationships (e.g., greater than fourth-order). In some examples, the engagement graph 133 define second-order relationships between user accounts 141 based on whether user accounts 141 are connected to other user accounts 141 in the connection graph 134, whether user accounts 141 have mentioned (or identified) other user accounts 141 in messages posted to the messaging platform 104, whether user accounts 141 has engaged with (e.g., liked, favoritized, starred, etc.) messages posted by other user accounts 141, and/or whether user accounts 141 have re-shared messages posted by other user accounts 141, etc.

For example, message D may be included on the ranked list 116 (or the candidate subset 112). The messaging platform 104 may determine that message D has been posted from user account 141c. The messaging platform 104 may determine, using the engagement graph(s) 133 that the user account 141a has an indirect relationship with the user account 141c. In some examples, the indirect relationship is a second-order relationship. In some examples, the indirect relationship is a two-hop relationship. If the user account 141a has an indirect relationship with the user account 141c, the user account 141a is not directly connected to the user account 141c in the connection graph 134.

The user account 141a may be connected to one or more intermediate user accounts in the connection graph 134 and the intermediate user accounts may have engaged with (e.g., favoritized or liked) one or more messages posted by the user account 141c. This indirect relationship may be an example of a follower-to-favoritize relationship. Another type of indirect relationship is the reverse of the follower-to-favoritize relationship (e.g., favoritize-to-follower relationship) where the user account 141a has engaged with (e.g., favoritized or liked) one or more messages posted by one or more intermediate accounts and the intermediate accounts are connected to the user account 141c in the connection graph 134.

However, the user account 141a may have other types of indirect relationships with the user account 141c such as a follower-to-follower relationship or a favoritize-to-favoritize relationship. Other types of indirect relationships may include the user account 141a engaging with (e.g., favoritize or like) messages from intermediate user account(s) and the intermediate user account(s) mentioning or identifying the user account 141c in messages posted by the intermediate user account(s). This type of indirect relationship may be an example of a favoritize-to-mention relationship. In some examples, the connection graph 134 defines unidirectional relationships between user accounts 141a. For example, if the user account 141a follows an intermediate user account, the user account 141a may receive messages posted by the intermediate user account in the timeline of the user account 141a (not necessarily the reverse situation). However, if the intermediate user account also follows the user account 141a, the intermediate user account may receive messages posted by the user account 141a. When two user accounts 141 follow each other, the relationship in the connection graph 134 may be referred to as mutual follows. As indicated above, other terms may be used instead of follow/follows/following such as friend, friending, adding, subscribing to, etc. In some examples, the connection graph 134 defines bidirectional relationships and/or a combination of unidirectional and bidirectional relationships.

In some examples, the indirect relationships include favoritize-to-mutual follow relationships. In some examples, the indirect relationships include favoritize-to-message reshares, where the user account 141a has engaged with (e.g., favoritized or liked) messages posted by intermediate user account(s) and the intermediate user account(s) have re-shared messages posted by the user account 141C.

In response to obtaining a graph engagement signal 122 for message D, the prediction manager 114 may increase the ranking associated with message D. For example, the graph engagement signal 122 indicates that the user account 141a has an indirect relationship with message D’s author (e.g., user account 141c). The increased ranking may cause message D to be displayed before (and/or with higher priority than) other lower ranked messages.

The messaging platform 104 may include a social context engine 120 configured to determine whether or not to insert a social context object 124 for a message authored by a user account 141 having an indirect relationship with the viewer (e.g., user account 141a). A social context object 124 can be a user interface (UI) element associated with the message, which indicates a social context of the message with respect to the viewer. For example, the UI element can include text, one or more icons, images, animations, sounds, colors, etc. associated with the message to indicate the social context of the message with respect to the viewer. The social context object 124 may provide information about the indirect relationship. For example, suppose the user account 141a follows a number of intermediate user accounts and those intermediate user accounts have favoritorized or liked messages authored by the user account 141c and the ranked list 116 includes message D. The social context engine 120 may transmit information to insert a social context object 124 in message D (or in a location that is close to message D) that may state “People you follow usually like C’s messages” when message D is displayed. However, the type of social context object 124 is dependent upon the type of indirect relationship identified by the graph engagement signal 122 associated with message D. For example, if the user account 141a has favoritized or liked messages posted by intermediate user accounts and the intermediate user accounts have favoritized or liked messages posted by the user account 141c, the social context object 124 may state “Some accounts you like often like C’s messages.”

The timeline manager 142 may transmit information to the client application 154 to render the ranked list 116 (or a portion thereof) and any relevant social context objects 124. In some examples, if the ranked list 116 includes a number of messages exceeding a threshold level, the timeline manager 142 may select a portion of the ranked list 116. For example, if the ranked list 116 includes 150 messages, the timeline manager 142 may return the top X number (e.g., top 50 messages) from the ranked list 116. Then, when the user submits a request to view additional messages, the timeline manager 142 may return the next X number (e.g., next 50 messages) from the ranked list 116 and so forth.

Referring to FIG. 1B, the light ranking manager 110 may obtain signals 106 in response to receipt of the conversation view request 121. In some examples, the signals 106 are generated by the light ranking manager 110. In some examples, the signals 106 are obtained from one or more data services 166 of the messaging platform 104. The light ranking manager 110 may identify the conversation graph 126 associated with the message subject to the conversation view request 121 and identify the message identifiers of the messages included in the conversation graph 126. The light ranking manager 110 may derive the signals 106 to perform the light ranking.

The data service(s) 166 may be components on the messaging platform 104 that compute or otherwise derive data obtained by the messaging platform 104 and/or the client application 154. In some examples, the light ranking manager 110 may communicate with the data services 166 over a server communication interface. In some examples, the light ranking manager 110 may obtain at least some of the signals 106 from the data service(s) 166 via one or more APIs. In some examples, in response to the conversation view request 121, the light ranking manager 110 may transmit a thrift call or a remote procedure call (RPC) to data service(s) 166 and then receive at least some of the signals 106 from the relevant data service(s) 166. In some examples, the light ranking manager 110 may transmit a representational state transfer (REST) request to the data service(s) 166 and then receive at least some of the signals 106 from the relevant data service(s) 166. In some examples, the light ranking manager 110 communicates with the data service(s) 166 via a GraphQL request. In some examples, the light ranking manager 110 obtains some of the signals 106 from other components of the messaging platform 104 including the conversation graph manager 136 and/or the timeline manager 142.

The signals 106 may include one or more signals relating to the quality of the messages of the conversation graph 126. The signals 106 may include metadata-based signals 160, health-based signals 162, and/or engagement-based signals 164. In some examples (although not shown in FIG. 1B), the signals 106 include the graph engagement signals 122.

In some examples, the metadata-based signals 160 may include whether or not a message is a deleted message, whether or not an author of a message is a focal author, whether or not an author of a message is a root author, and/or whether or not a message is a message of the viewer. In some examples, the engagement-based signals 164 include the number of engagement counts with a respective message. The number of engagement counts may represent the number of times users have engaged with the message of the conversation graph 126. In some examples, the engagement count includes the number of times that the message has been favoritized (e.g., liked) by users of the messaging platform 104. In some examples, the engagement count includes the number of times that the message has been reshared by users of the messaging platform 104. In some examples, the engagement counts include the number of times that the message has received a reply posted by users of the messaging platform 104. In some examples, the engagement count includes a combination of the number of times that the message has been favoritized, reshared, and replied.

The health-based signals 162 may include signals relating to the health of the messages on the messaging platform 104 (e.g., how abusive, offensive, and/or toxic the messages are). In some examples, the light ranking manager 110 may obtain the health-based signals 162 from one or more data services 166. The data service(s) 166 may use one or more machine-learning models (e.g., neural network(s)) to generate the health-based signals 162. In some examples, the light ranking manager 110 may transmit the message identifiers of the messages of the conversation graph 126 to the data service(s) 166 and receive the health-based signals 162 from the data service(s) 166.

In some examples, referring to FIG. 1C, the health-based signals 162 include a toxicity signal 161 that represents a predicted level of toxicity or abusive content. In some examples, the toxicity signal 161 includes a value between a first value (e.g., zero) and a second value (e.g., one). In some examples, the data of a message is inputted to a predictive model (e.g., a neural network) and the predictive model is configured to predict whether the message is toxic or very toxic based on the content of the message. The toxicity signal 161 may include a value that represents whether a respective message is not toxic, toxic, or very toxic.

The health-based signals 162 may include a reporting signal 163 that represents a predicted level of a target (mentioned) user blocking, muting, or reporting the message. In some examples, the reporting signal 163 is considered a blocking signal. In some examples, the reporting signal 163 includes a value between a first value (e.g., zero) and a second value (e.g., one). In some examples, the reporting signal 163 may include a value that represents a likelihood that a respective message will be blocked, muted, and/or reported. In some examples, a predictive model (e.g., a neural network) may predict a likelihood that the message will be blocked, muted, or reported based on a plurality of features. The plurality of features may include features relating to the content of the message (e.g., text length, punctuations, hashtags, emojis, mentions, and/or if the text is abusive, etc.). The plurality of features may include features about the source user and the target user (e.g., the number of times the source and/or target user was blocked/reported/muted, the follower count, whether the source and/or target user has a profile or a profile that is available to view, the number of messages posted by the source and/or target user, the account age, profile name, description, screen name, and/or URL, etc.). In some examples, the reporting signal 163 may represent a predicted level that a respective message will receive any report.

In some examples, the health-based signals 162 may include a spam signal 165 that represents a predicted level of another user reporting the message as spam (when the message is created). In some examples, the spam signal 165 includes a value between a first value (e.g., zero) and a second value (e.g., one). In some examples, a predictive model (e.g., a neural network) may predict a likelihood that the message will be reported as spam based on a plurality of features. The plurality of features may include features relating to the content of the message (e.g., text length, punctuations, hashtags, emojis, mentions, and/or if the text is abusive, etc.). The plurality of features may include features about the source user (e.g., the number of times the source user was blocked/reported/muted, the follower count, whether the source target user has a profile or a profile that is available to view, the number of messages posted by the source user, the account age, profile name, description, screen name, and/or URL, etc.).

The light ranking manager 110 includes a ranking unit 159 configured to rank the messages of the conversation graph 126 using the signals 106. In some examples, the ranking unit 159 may generate scores for the messages of the conversation graph 126 using the signals 106. In some examples, the ranking unit 159 includes a heuristic-based algorithm that uses the signals 106 to generate a ranked list 182 (e.g., an intermediate ranked list) and/or generate a score for each message of the conversation graph 126. In some examples, if the graph engagement signals 122 are used by the light ranking manager 110, the ranking unit 159 may increase the score for a message having an author with an indirect relationship (e.g., a two-order relationship) with the user account 141a. In some examples, the ranked list 182 includes a score associated with a respective message of the conversation graph 126. In some examples, the ranking unit 159 includes one or more predictive models. In some examples, the ranking unit 159 includes one or more neural networks.

In some examples, the ranking unit 159 may apply a series of rules to determine the ranked list 182, where a message not marked for deletion is ranked higher than a message marked for deletion, a message by the focal author is ranked higher than other messages, a message by the root author is ranked higher than other messages, a message by the viewer is ranked higher than other messages, and a message with a higher engagement count is ranked higher than a message with a lower engagement count. In some examples, the ranking unit 159 may combine the health-based signals 162 (e.g., the toxicity signal 161, the reporting signal 163, and the spam signal 165) to produce a composite health signal, where a message having a higher composite health signal is ranked lower than a message having a lower composite health signal.

The light ranking manager 110 includes a system load unit 172 configured to determine the quantity of messages selected for the candidate subset 112 based on a system load metric 167 (e.g., a latency 168) and/or a size 170 of the conversation graph 126. The candidate subset 112 may include a portion of the messages in the conversation graph 126. The light ranking manager 110 may determine which and how many messages are included within the candidate subset 112. The system load unit 172 may determine the amount (e.g., percentage of) of pruning based on the system load metric 167 and/or the size 170 of the conversation graph 126. For example, if the system load metric 167 is relatively high (e.g., greater than a threshold), the system load unit 172 may increase the number of messages that are pruned (e.g., not included within the candidate subset 112). If the system load metric 167 is relatively low (e.g., less than a threshold), the system load unit 172 may decrease the number of messages that are pruned. In some examples, if the size 170 of the conversation graph 126 is relatively high (e.g., greater than a threshold), the system load unit 172 may increase the number of messages that are pruned. If the size 170 of the conversation graph 126 is relatively low (e.g., less than a threshold), the system load unit 172 may decrease the number of messages that are pruned.

When a conversation view request 121 is received, the system load unit 172 may obtain the system load metric 167. The system load metric 167 may be a parameter that represents a level of system load caused by servicing conversation view requests 121. In some examples, during periods of time when there are many conversation view requests 121 and/or when large conversation graphs 126 are requested for viewing, the system may be under heavier loads, which can cause delays/failures in rendering messages from a conversation graph 126. In some examples, the system load metric 167 may be a level of CPU usage provided by the ranking engine 108. In some examples, the system load metric 167 may be a level of memory allocation used by the ranking engine 108.

In some examples, the system load metric 167 includes a latency 168. In some examples, the latency 168 is the time delay (e.g., time window, time interval) from receiving a conversation view request 121 to rendering messages from the conversation graph 126 on the user interface of the client application 154. In some examples, the latency 168 may be the latency of executing a conversation view request 121. In some examples, the latency 168 is the period of time from receipt of a conversation view request 121 to rendering the ranked list 116 (or a portion thereof) on the client application 154. In some examples, the latency 168 is the average latency of executing conversation view requests 121 over a period of time (e.g., three minutes).

The system load unit 172 may compute a system load factor 174 based on the system load metric 167. Although some of the description uses latency 168 as an example of the system load metric 167, it is understood that the system load metric 167 may encompass any type of metric for measuring the system’s load. The system load factor 174 may be a value within a range of values. In some examples, the system load factor 174 may be a first value (e.g., zero), a second value (e.g., one), or one of a series of values between the first value and the second value. In some examples, the system load unit 172 may compare the system load metric 167 (e.g., latency 168) to an upper threshold 171 and/or a lower threshold 173 to compute the system load factor 174.

If the system load metric 167 is equal to or less than the lower threshold 173, the system load unit 172 may determine the first value (e.g., zero) for the system load factor 174. In some examples, if the system load metric 167 is less than the lower threshold 173, the messaging platform 104 may be operating in a normal mode. If the system load metric 167 is equal to or higher than the upper threshold 171, the system load unit 172 may determine a second value (e.g., one) for the system load factor 174. In some examples, if the system load metric 167 is higher than the upper threshold 171, the messaging platform 104 may be operating in a high system load mode. In some examples, if the latency 168 is a value between the lower threshold 173 and the upper threshold 171, the system load unit 172 may compute a value for the system load factor 174, where the value is between the first value and the second value. In some examples, the value for the system load factor 174 may linearly increase from the lower threshold 173 to the upper threshold 171.

In some examples, the system load unit 172 may compute a conversation size factor 176 based on the size 170 of the conversation graph 126. The size 170 is determined based on how many messages the conversation graph 126 includes. The conversation size factor 176 may be a value within a range of values. In some examples, the conversation size factor 176 may be a first value (e.g., zero), a second value (e.g., one), or one of a series of values between the first value and the second value. In some examples, the system load unit 172 may compare the size 170 to an upper threshold 175 and/or a lower threshold 177 to compute the conversation size factor 176.

In some examples, if the size 170 is less than or equal to the lower threshold 177, the system load unit 172 may determine the conversation size factor 176 as the first value (e.g., zero). In some examples, if the size 170 is equal to or greater than the upper threshold 175, the system load unit 172 may determine the conversation size factor 176 as the second value (e.g., one). In some examples, if the size 170 is between the lower threshold 177 and the upper threshold 175, the system load unit 172 may compute the value of the conversation size factor 176 as being a value between the first value and the second value. In some examples, the value of the conversation size factor 176 may increase (e.g., linearly increase) from the lower threshold 177 to the upper threshold 175. In some examples, when the size 170 is between the lower threshold 177 and the upper threshold 175, the system load unit 172 may calculate the conversation size factor 176 as (conversation size — lower threshold) / (lower threshold — upper threshold).

The system load unit 172 may compute a pruning factor 178 based on the system load factor 174 and the conversation size factor 176. In some examples, the pruning factor 178 may be computed by using the system load factor 174 and the conversation size factor 176 in a ratio, a scoring algorithm (e.g., weighted scoring algorithm), or other function that computes a value using the system load factor 174 and the conversation size factor 176. The pruning factor 178 may determine the level (or amount) of pruning applied to the conversation graph 126 or the number of messages included within the candidate subset 112. In some examples, the pruning factor 178 includes a percentage of the conversation graph 126. In some examples, the pruning factor 178 includes a percentage of messages to be pruned from the conversation graph 126, where the remaining messages are the messages included in the candidate subset 112. In some examples, the pruning factor 178 includes a percentage of messages to be included within the conversation graph 126. In some examples, the pruning factor 178 includes a value within a range of ranges (e.g., from a lower bound to an upper bound), where each value is associated with a percentage of messages to be pruned or included in the candidate subset 112. If the pruning factor 178 is closer to the lower bound, a lower percentage of messages are pruned. If the pruning factor 178 is closer to the upper bound, a higher percentage of messages are pruned.

In some examples, the system load unit 172 may compute the pruning factor 178 based on the system load factor 174, the conversation size factor 176, and an adjusted intercept value. The adjusted intercept value may be computed based on the lower bound, the upper bound, and the system load factor 174 (e.g., adjusted intercept value = lower bound + system load factor 174 * (upper bound - lower bound)). In some examples, the pruning factor 178 = adjusted intercept + (1 - adjusted intercept) * conversation size factor 176.

The light ranking manager 110 may obtain the pruning factor 178 and select messages from the ranked list 182 according to the pruning factor 178. For example, if the pruning factor 178 indicates that 37% of messages are to be pruned, the message selector 180 may remove the bottom 37% of messages from the ranked list and identify the top 63% of messages from the ranked list 182 as the candidate subset 112. In this manner, messages having a higher quality are selected for heavier ranking while balancing the load on the system.

In some examples, the message selector 180 selects the messages for the candidate subset 112 using the scores from the first level ranking. In some examples, the message selector 180 may select a message having the highest score (e.g., highest rank) from a candidate list. The candidate list first includes the direct replies to the focal message (e.g., all the direct replies to the focal message) along with their scores assigned from the first level ranking. The message selector 180 may select the highest scoring message to be included in the candidate subset 112 and may add any replies to the selected message in the candidate list. This process continues until the candidate subset 112 has a number of messages that satisfy the pruning factor 178. For example, if the conversation graph 126 has one hundred messages and the pruning rate is 30%, the process continues until the candidate subset has seventy messages. This methodology may ensure that the conversation graph 126 is connected after the pruning step and no message is served without their parent message.

Referring to FIGS. 1A and 1D, the prediction manager 114 receives the candidate subset 112 from the light ranking manager 110 and ranks the messages of the candidate subset 112 according to a plurality of signals 118 to generate a ranked list 116.

In response to the prediction manager 114 receiving the candidate subset 112, the prediction manager 114 may obtain the signals 118 relating to the messages of the candidate subset 112 from one or more data services 166. The signals 118 may include signals generated by the messaging platform 104 and/or generated by the client application 154 that relate to predicting user outcomes for displaying messages on the client application 154. For example, the signals 118 may include signals generated by the client application 154 based on the user’s interaction with the client application 154. The signals generated by the client application 154 may be transmitted to the messaging platform 104 for storage thereon.

The signals generated by the client application 154 may include signals representing engagement information such as positive user engagements with messages (e.g., favoritizing, likes, re-sharing), and/or negative user engagements with the messages (e.g., the reporting of abusive content). In some examples, the signals 118 may include signals generated by the messaging platform 104. In some examples, the signals generated by the messaging platform 104 may include signals representing data generated from the user’s connection graph 134, data generated from the conversation graph 126, data generated from user behavior on the platform (e.g., the number of times a user has engagement with messages, etc.), and/or data generated from the content of the messages such as the result of a semantic analysis that predicts user sentiment or the result of a topical analysis that determines a topic of one or more messages.

As shown in FIG. 1E, the signals 118 may include data structure-related signals 101 relating to a conversation graph 126, health-related signals 103 related to the health of providing messages from the conversation graph 126 to the user of the client application 154, engagement signals 105 related to user engagements on the messages of the conversation graph 126, social graph signals 107 related to data from the user’s connection graph 134, historical aggregate signals 109 related to data aggregated by the messaging platform 104, content-related signals 111 related to the content of the messages of the conversation graph 126, and/or similarity signals 113 representing how similar a message is to other messages that the user has favoritized or liked and/or how similar the user is to other users that have engaged with the message. In some examples, the health-related signals 103 include one or more of the health-based signals 162 explained with reference to FIG. 1C. However, the signals 118 may include any type of category or granularity of signals that relate to predicting user outcomes from displaying messages.

The data structure-related signals 101 may include signals related to data from the conversation graph 126. In some examples, the data structure-related signals 101 may include signals representing the number of nodes 128, the number of edges 130, the number of branches 132, the length or size of each branch 132, the number of parent nodes, the number of children nodes, the number of leaf nodes, the height of the conversation graph 126 (e.g., the length of the longest path to a leaf node), and/or the depth of a node (e.g., the depth of a node is the length of the path to the root node). In some examples, the data structure-related signals 101 include one or more signals representing the number of unique authors in the conversation graph 126 or a subset of the conversation graph 126 such as a branch 132. In some examples, the data structure-related signals 101 include signals representing a location of a message having a certain type of data (e.g., an image, video, a link to video, etc.) within the conversation graph 126. In some examples, with respect to a particular message within the conversation graph 126, the data structure-related signals 101 may include signals representing whether the message is a child node, whether the message is a parent node, whether the message is a leaf node, the location of the message within the conversation graph 126, the location of a branch 132 that includes the message, the size of the branch 132 that includes the message, the depth of the message within the conversation graph 126.

The data structure-related signals 101 may include branch contextual features. In some examples, the data structure-related signals 101 include signals representing the number of replies within a branch 132, the number of conversations within a branch 132, the number of conversations within a branch 132 between the user of the client application 154 and an author of the root message, the number of conversation within a branch 132 between the user of the application 154 and a user mentioned in a new message, and/or the number of conversations between a specific node (e.g., a focal message) and a leaf node. In some examples, with respect to branch contextual features, a conversation may be defined as a back and forth between at least two users. In some examples, a conversation may be defined as a message posted by user A, a reply posted by user B, and then a reply posted by user A.

In some examples, the conversation graph manager 136 may receive the conversation identifier from the prediction manager 114, and then derive or determine the data structure-related signals 101 from the conversation graph 126 according to the conversation identifier and may store the data structure-related signals 101 in a data storage on the messaging platform 104. In some examples, in response to the conversation view request 121, the prediction manager 114 may control the conversation graph manager 136 to derive or determine the data structure-related signals 101 and then receive the data structure-related signals 101 from the conversation graph manager 136 to be used with the predictive models 117 to determine the predictive outcomes 125. In some examples, the prediction manager 114 may derive or determine the data structure-related signals 101 from the conversation graph 126. In some examples, in response to the conversation view request 121, the prediction manager 114 may transmit the conversation identifier to the conversation graph manager 136, and then receive the conversation graph 126 to derive or determine the data structure-related signals 101 from the conversation graph 126.

The health-related signals 103 may include signals that represent the health of presenting a message of the conversation graph 126 to the user of the client application 154. In some examples, the health-related signals 103 may include signals representing whether the user of the client application 154 has restricted (e.g., blocked, muted, etc.) an author of a message in the conversation graph 126 in the past. The health-related signals 103 may be stored in a data storage on the messaging platform 104. In some examples, the prediction manager 114 may transmit a request to a data service 166 (e.g., a health data service) to obtain the health-related signals 103, where the request may include the message identifiers 139 of the messages of the conversation graph 126 and/or the user identifier 137 of the user of the client application 154.

The engagement signals 105 may represent user engagement data associated with the messages of the conversation graph 126. In some examples, the engagement signals 105 include signals representing the number of engagements (e.g., number of times the messages has been favoritized or liked, the number or replies to the message, the number of times the message has been re-shared) with respect to a message of the conversation graph 126. In some examples, the engagement signals 105 include one or more signals representing the engagements of users that follow the user of the client application 154 in the user’s connection graph 134 (e.g., whether the message has one or more engagements provided by users that follow the user of the client application 154 in the user’s connection graph 134). In some examples, the prediction manager 114 obtains the engagement signals 105 from a data service 166 that stores the engagement data. In some examples, the prediction manager 114 may transmit a request that may include the message identifiers of the conversation graph 126, and the prediction manager 114 may receive the engagement signals 105 from the data service 166.

The social graph signals 107 may include signals representing information from the connection graph 134. In some examples, the social graph signals 107 includes signals representing the number of times that the user of the client application 154 has favoritized or liked messages of an author of a message over a period of time, whether the user is linked to the author of a message in the connection graph 134, and/or the number of times that the user has re-shared or replied messages of an author of a message over a period of time. In some examples, the prediction manager 114 obtains the social graph signals 107 from a data service 166 that stores the social graph signals. In some examples, the prediction manager 114 may transmit a request that may include a user identifier of the user of the client application 154, and the prediction manager 114 may receive the social graph signals 107 from the data service 166. In some examples, the signals 118 include graph engagement signals 122. In some examples, the graph engagement signals 122 are considered a subset of the social graph signals 107. In some examples, the graph engagement signals 122 including information about indirect relationships between the user account 141a and user accounts 141 of authors that have messages in the candidate subset 112 or the ranked list 116. Further details about the graph engagement signals 122 are explained later in the disclosure.

The historical aggregate signals 109 may include signals representing a user behavior on the messaging platform 104. In some examples, the historical aggregate signals 109 may include signals representing the number of times the user of the client application 154 has favoritized messages on the messaging platform 104 during a period of time, the number of times the user of the client application 154 has re-shared messages on the messaging platform 104 during a period of time, and/or the number of times the user of the client application 154 has replied to messages on the messaging platform 104 during a period of time. The period of time may be within the last day, last month, or last year, etc. In some examples, the historical aggregate signals 109 may include signals representing the number of times the user of the client application 154 has favoritized, liked, re-shared, and/or replied to messages that include an image or video.

In some examples, the historical aggregate signals 109 may include signals representing the number of times that the user of the client application 154 has favoritized, liked, re-shared, and/or replied to messages that are from accounts 141 linked to the user in the connection graph 134, and/or the number of times that the user has favoritized, liked, re-shared, and/or replied to messages that are from accounts 141 not linked to the user in the connection graph 134. In some examples, the prediction manager 114 obtains the historical aggregate signals 109 from data storage on the messaging platform 104. In some examples, the prediction manager 114 transmits a request to a data service 166 to obtain the historical aggregate signals 109. In some examples, the request includes a user identifier of the user of the client application 154. In some examples, the historical aggregate signals 109 includes batch aggregate information and real-time aggregate information. The batch aggregate information may include a relatively long history (e.g., greater than 50 days). In some examples, the batch aggregate information may not include interaction from the last day (or last few days). The real-time aggregate information may include relatively recent interaction history (e.g., within the last 30 minutes or so).

The content-related signals 111 may include signals representing one or more aspects of the contents of a message of the conversation graph 126. In some examples, the content-related signals 111 may include signals representing the length of the message, and/or whether the content includes text, video, or image. In some examples, the prediction manager 114 obtains the content-related signals 111 from data storage on the messaging platform 104. In some examples, the prediction manager 114 transmits a request to a data service 166 to obtain the content-related signals 111. In some examples, the request includes message identifiers of the messages of the conversation graph 126.

The similarity signals 113 may include one or more signals representing how similar a message is to other messages that the user has favoritized or liked. For example, the similarity signals 113 may represent a level of similarity between a particular message and one or more other messages that the user has favoritized or liked, and if the level of similarity is relatively high, it may provide an indication of a potential positive engagement. In some examples, the similarity signals 113 may include one or more signals representing how similar the user is to other users that have engaged with the message. For example, if a user profile of the user is determined as relatively similar to user profiles that have engaged with the message, it may provide an indication of a potential positive engagement. In some examples, the prediction manager 114 may obtain the similarity signals 113 from data storage on the messaging platform 104. In some examples, the prediction manager 114 may transmit a request to a data service 166 to obtain the similarity signals 113. In some examples, the request may include message identifiers and/or the user identifier of the user.

In some examples, technical difficulties or hurdles exist in order to obtain at least some of the signals 118 used for the prediction (e.g., especially for signals related to viewer-author relationships whenever a message goes viral). Popular messages may have a relatively large amount of responses (e.g., in some cases, more than 80 K). This also means that many users may try and view the popular message at the same time. For each viewer, the messaging platform 104 may obtain their relationship with all the authors that have replied to the popular message. Using the techniques described above, the messaging platform 104 may be able to filter the total number of messages from 80 K to 4 K, which may still mean that there can be 4 K viewer author pairs for which to obtain relationship signals.

Also, in some examples, the viewer-author relationship may not even exist because the viewer would not be following the author. To handle these types of situations, instead of querying by viewer-author as a key to a data service 166, the messaging platform 104 can query by the viewer identifier and get their relationships with all other authors at once. Then, the messaging platform 104 can determine if any authors overlap with the authors of the replies and keep the signals where relevant. This reduces over the network calls by a relatively large magnitude as instead of making 4 K calls per viewer, the prediction manager 114 may generate and send one call.

Another technical difficulty may exist for message-level signals. For example, for large conversations, the messaging platform 104 may query other data services 166 with 4 K queries for each viewer. This could lead to “hot-key” problems where the data service 166 receives too many queries for the same message identifier. To overcome the above-identified difficulty, the messaging platform 104 may use in-memory caching. The service would cache the features in memory if the underlying data service 166 indicates a hot-key. For example, a message T goes viral and has responses R1,R2...R4000, and the message feature is the number of characters in the message. Then, 1000 users send requests for the same message simultaneously (or around the same time). If the data service 166 indicates a hot-key, the messaging platform 104 can store the character value for R1,R2..R4000 each in memory for a very short duration and just use them instead of calling the data service 166 for each user.

The prediction manager 114 includes an engagement predictor 115 configured to determine one or more predictive outcomes 125 of each message of the candidate subset 112 using the signals 118. In some examples, the engagement predictor 115 inputs the signals 118 to one or more predictive models 117 to compute the predictive outcomes 125.

The predictive models 117 are predictive models trained by one or more machine learning algorithms inputted with training data. The machine learning algorithms may include one or more of Markov models, logistic regression, decision tree analysis, random forest analysis, neural nets, and combinations thereof. Generally, machine learning is the field where a computer learns to perform classes of tasks using the feedback generated from experience or data that the machine learning process acquires during computer performance of those tasks. In supervised machine learning, the computer can learn one or more rules or functions to map between example inputs and desired outputs as predetermined by an operator or programmer. Labeled data points can then be used in training the computer. Unsupervised machine learning can involve using unlabeled data, and the computer can then identify implicit relationships in the data, for example by reducing the dimensionality of the data set.

The predictive models 117 may one predictive model 117 or multiple predictive modes 117 such as a positive engagement model, a negative engagement model, and a reciprocal engagement model. The predictive model(s) 117 may compute the positive engagement probability 127, the negative engagement probability 129, and the reciprocal engagement probability 131. For example, in response to the conversation view request 121 (e.g., the user selecting message B), the engagement predictor 115 may obtain the signals 118 relating to the messages of the candidate subset 112 and apply the signals 118 (which also includes the user identifier and the message identifier) to the predictive models 117 to determine the positive engagement probability 127, the negative engagement probability 129, and/or the reciprocal engagement probability 131, respectively.

The positive engagement probability 127 indicates a probability value that the user is predicted to positively view or engage with the message. In some examples, the probability value for the positive engagement probability 127 is a number (x) between a first value and a second value, where the first value represents a zero chance that the user is predicted to positively view or engage with the message, and the second value represents a 100% chance that the user is predicted to positively view or engage with the message. In some examples, the probability value for the positive engagement probability 127 is a positive number. In some examples, the first value is zero and the second value is one. However, the values for the first value and the second value may define any type of range (e.g., 0 to 1, 0 to 50, 0 to 100, etc.). In other words, the positive engagement probability 127 indicates a level of likeliness that the user is predicted to favoritize, like, or share the message.

The negative engagement probability 129 indicates a probability value that the user is predicted to negatively view or engage with the message. In some examples, the probability value for the negative engagement probability 129 is a number (y) between a first value and a second value, where the first value represents a zero chance that the user is predicted to negatively view or engage with the message, and the second value represents a 100% chance that the user is predicted to negatively view or engage with the message. In some examples, the probability value for the negative engagement probability 129 is a negative number. In some examples, the first value is zero and the second value is negative one. However, the values for the first value and the second value may define any type of range (e.g., 0 to -1, 0 to -50, 0 to -100, etc.). In some examples, the negative engagement probability 129 indicates a level of likeliness that the user is predicted to block the author of the message, unfollow the author of the message, and/or report the message as abusive.

The reciprocal engagement probability 131 indicates a probability value that the user is predicted to continue to develop the conversation graph 126. In some examples, the probability value for the reciprocal engagement probability 131 is a number (z) between a first value and a second value, where the first value represents a zero chance that the user is predicted to continue to develop the conversation graph 126, and the second value represents a 100% chance that the user is predicted to continue to develop the conversation graph 126. In some examples, the probability value for the reciprocal engagement probability 131 is a positive number. In some examples, the first value is zero and the second value is one. However, the values for the first value and the second value may define any type of range (e.g., 0 to 1, 0 to 50, 0 to 100, etc.). In some examples, the reciprocal engagement probability 131 indicates a level of likeliness that the user is predicted to reply to the message, thereby further developing the conversation graph 126.

The prediction manager 114 includes an engagement scorer 119 computes the engagement values 123 for the messages in the candidate subset 112 using the predictive outcomes 125. The engagement value 123 may provide an overall engagement value for a respective message, which incentivizes more healthy conversations on the messaging platform 104. For example, with respect to a particular message of the candidate subset 112, the engagement scorer 119 may combine the positive engagement probability 127, the negative engagement probability 129, and the reciprocal engagement probability 131 to generate an engagement value 123, which can be used to select the most relevant nodes 128 for the user. For example, the engagement scorer 119 may combine the values of the predictive outcomes 125 to determine the engagement value 123 for a particular message. If the probability value of the negative engagement probability 129 is relatively high (e.g., having a greater negative value), this value may offset the positive values of the positive engagement probability 127 and the reciprocal engagement probability 131. In a simple example, if the positive engagement probability 127 is +10, the negative engagement probability 129 is -10, and the reciprocal engagement probability 131 is +10, the engagement value 123 for the message is +10.

In some examples, the engagement scorer 119 may apply weights with the predictive outcomes 125, and then compute the engagement value 123 based on the weighted positive engagement probability 127 the negative engagement probability 129, and the reciprocal engagement probability 131. In some examples, the weight applied to the reciprocal engagement probability 131 is greater than the weight applied to the negative engagement probability 129.

The engagement values 123 are used to select relevant messages or branches of messages within the conversation graph 126 to be rendered to the user. For example, the timeline manager 142 receives the engagement values 123 from the prediction manager 114 and uses the engagement values 123 to rank the messages in the conversation graph 126 (e.g., from highest to lowest). The timeline manager 142 may provide, over the network 150, at least a subset of the messages of the ranked list 116 to be rendered on the timeline 156 according to the rank. In some examples, the timeline manager 142 provides only a subset of the ranked list 116 to be rendered on the timeline 156, where the subset includes the higher ranked messages of the conversation graph 126. Then, the timeline manager 142 may receive a request for additional messages of the conversation graph 126 from the client application 154 (e.g., selects a user affordance to view more messages of the conversation graph 126), and the timeline manager 142 may select the next group of messages from the candidate subset 112 to be transmitted to the client application 154. In this manner, the messaging system 100 may collapse parts of the conversation graph 126 that are less likely to provide a positive engagement, but then surface those messages when requested by the user.

In some examples, the timeline manager 142 selects one or more branches 132 (or a subset of a branch 132) of the conversation graph 126 to be rendered on the timeline 156 using the engagement values 123. For example, if a branch 132 includes one or more nodes 128 having high engagement values 123 (or engagement values 123 over a threshold level), the timeline manager 142 may select the entire branch 132 to be rendered as part of the messages delivered to the client application 154 despite the fact that the branch 132 may include one or more nodes 128 having low engagement values 123 (or engagement values 123 below a threshold level) in order to provide the user more context about the conversation. In some examples, a particular branch 132 is associated with an overall engagement value which may be the average of the engagement values 123 for the nodes 128 within the particular branch 132. Then, the timeline manager 142 may rank the branches 132 according to their overall engagement values.

In some examples, the timeline manager 142 selects messages from the candidate subset 112 having high engagement values (or engagement values 123 over a threshold level) for inclusion in the set of messages provided to the client application 154. In some examples, the timeline manager 142 ranks the selected branches 132 and/or the messages of the candidate subset 112 according to highest to lowest engagement values 123 (e.g., where the branches 132 or the messages having the highest engagement values 123 are presented to the user first).

In some examples, the ranked list 116 represents a subset of the messages of the conversation graph 126 that are determined as relevant to the user. For example, some messages of the conversation graph 126 may be relevant to a first user while other messages of the conversation graph 126 may be relevant to a second user. In contrast, some conventional approaches use a voting-based mechanism that may provide the same view for each. In further detail, the engagement predictor 115 may obtain the signals 118 (e.g., engagement history, connection graph data, etc.) that are related to the first user and obtain the predictive outcomes 125 for each message in the candidate subset 112, which are then used to compute the engagement values 123. The timeline manager 142 may receive the engagement values 123 from the prediction manager 114, and then rank the messages of the candidate subset 112 using the engagement values 123.

However, with respect to the second user, the engagement predictor 115 may obtain the signals 118 related to the second user, obtain the predictive outcomes 125 that are tailored to the second user, which are then used to compute the engagement values 123. Then, the timeline manager 142 may rank the messages in the candidate subset 112 using the engagement values 123. As such, the messages of the ranked list 116 that are displayed on the client application 154 for the second user may be different from the messages of the ranked list 116 that are displayed on the client application 154 for the first user.

FIG. 1F illustrates an example of a graph relationship engine 135 of the messaging platform 104 according to an aspect. The graph relationship engine 135 may derive, generate, or obtain one or more engagement graphs 133 using information from the connection graph 134 (e.g., follows, mutual follows, friends, subscribers, etc.) and the engagements (e.g., re-shares, likes, favoritizes, mentions) associated with the user accounts 141 of the messaging platform 104. In some examples, an engagement graph 133 may store indirect relationship information about the user accounts 141 of the messaging platform. In some examples, the indirect relationships are second-order relationships. In some examples, the indirect relationships are two-hop relationships.

FIG. 1G illustrates a portion of an engagement graph 133 according to an aspect. The engagement graph 133 includes information that represents the user account 141a, intermediate user accounts 141b, and the user account 141c. In the engagement graph 133, the user accounts 141 may be represented by nodes and connections between the nodes may be represented by edges. In some examples, the engagement graph 133 includes a directed graph having edges that point in a particular direction (e.g., from node to another node). In some examples, the engagement graph 133 includes an undirected graph with undirected edges. In some examples, the engagement graph 133 includes a combination of a directed graph and an undirected graph.

The engagement graph 133 includes engagement edges 144a that connect the user account 141a to intermediate user accounts 141b (e.g., B1, B2, B3, B4, B5, B6). The engagement edges 144a may represent the first relationship in the two-order relationship. In the example of FIG. 1G, the engagement edges 144a may be considered following (or friend) relationships, where the user account 141a is following B1 through B6 in the connection graph 134 (e.g., user account 141a would receive messages posted by B1 through B6). The engagement graph 133 includes engagement edges 144b that connect the intermediate user accounts 141b (e.g., B3, B4, B5, B6, B7) to the user account 141c. The engagement edges 144b may represent the second relationship in the two-order relationship. In the example of FIG. 1G, the engagement edges 144b may be considered favoritize relationships, where the intermediate user account(s) 141b have favoritized one or more messages posed by the user account 141c. The type of indirect relationship depicted in FIG. 1G may be considered a follow-to-favoritize relationship. The type of indirect relationship may be defined based on the type of the engagement edges 144a and the type of the engagement edges 144b.

The engagement graph 133 may specify different types of engagement edges 144a and different types of engagement edges 144b. For example, the engagement edges 144a may be favoritize relationships, where the user account 141a have favoritized one or more messages posted by the intermediate user account(s) 141b. In some examples, the engagement edges 144a may be mutual follow relationships, where the user account 141a follows intermediate user accounts 141b and the intermediate user accounts 141b follow the user account 141a (e.g., they follow each other). The engagement edges 144b may be follow relationships (e.g., unidirectional such as the user account 141a following B1). In some examples, the engagement edges 144b may be mention relationships, where the intermediate user accounts 141b have mentioned or identified the user account 141c in one or more messages posted by an intermediate user accounts 141b. Mentioning a particular user account 141 (e.g., adding a username) in a message may link the mentioned user account 141 to the message, which may cause the mentioned user account 141 to receive the message. In some examples, the engagement edges 144b may be mutual follow relationships. In some examples, the engagement edges 144b may be reshare relationships, where intermediate user accounts 141b have re-shared one or more messages posted by the user account 141c.

The engagement graph 133 may identify one or more indirect relationships such as favoritize-to-favoritize relationships, favoritize-to-follow relationships, favoritize-to-mention relationships, favoritize-to-mutual follow relationships, favoritize-to-reshare relationships, follow-to-favoritize relationships, follow-to-follow relationships, follow-to-mention relationships, follow-to-mutual follow relationships, follow-to-reshare relationships, mutual follow-to-favoritize relationships, mutual follow-to-follow relationships, mutual follow-to-mutual follow relationships, mutual follow-to-mention relationships, mutual follow-to-reshare relationships. In some examples, a particular engagement graph 133 specifies a particular type of indirect relationship, where the graph relationship engine 135 may include one or more engagement graph 133 (e.g., one per type of indirect relationship). In some examples, an engagement graph 133 encompasses more than one indirect relationship, a subset of indirect relationships, or all of the indirect relationships.

The graph relationship engine 135 may be included as one or more data services 166, which are invoked by other components of the messaging platform 104 such as the prediction manager 114, the social context engine 120, and/or the timeline manager 142. For example, another component or data service 166 may invoke the graph relationship engine 135 by transmitting a request to receive graph engagement signals 122 about indirect relationships between user accounts 141 and then receive the graph engagement signals 122 in response to the request.

In some examples, the graph relationship engine 135 may receive user identifiers 137 and/or message identifiers 139 and determine whether a pair of user accounts 141 have an indirect relationship 146 (e.g., a two-order relationship) using the engagement graph(s) 133. In some examples, for a pair of user accounts 141, the graph relationship engine 135 may generate a graph engagement signal 122. In some examples, the graph engagement signal 122 is generated for a respective message authored by a user account 141c having an indirect relationship with the user account 141a. In some examples, the graph relationship engine 135 may receive a user identifier 137 corresponding to the user account 141a and a plurality of message identifiers 139 that identify a set of messages. In some examples, the message identifiers 139 may correspond to messages on the ranked list 116 or candidate subset 112. In some examples, the message identifier 139 may correspond to messages from a conversation graph 126. In some examples, the graph relationship engine 135 may determine which user accounts 141 have authored the messages corresponding to the message identifiers 139 and then determine whether the user account 141a has an indirect relationship with one or more of the authors in the engagement graph(s) 133. In some examples, the graph relationship engine 135 may communicate with other data services 166 to obtain the user accounts 141 that have authored messages for message identifiers 139.

The graph relationship engine 135 may generate a graph engagement signal for a message and/or a pair of user accounts 141 having an indirect relationship 146 as defined in the engagement graph(s) 133. The graph engagement signal 122 may identify a message identifier 139 of a message that pertains to the indirect relationship 146. In some examples, the graph engagement signal 122 may identify user identifiers 137 for a pair of user accounts 141, e.g., user account 141a and user account 141c.

The graph engagement signal 122 may specify the type of indirect relationship 146. For example, the graph engagement signal 122 may include information about the indirect relationship 146 such as the identification of a first relationship between the user account 141a and one or more intermediate user accounts 141b and a second relationship between the intermediate user accounts 141b and the user account 141c. In some examples, the indirect relationship 146 may be defined based on an edge connection type 198a (e.g., the type of the engagement edges 144a) and an edge connection type 198b (e.g., the type of the engagement edges 144b).

In some examples, the graph relationship engine 135 generates graph engagement data 140 about one or more statistics about the indirect relationship 146, and the graph engagement signal 122 includes the graph engagement data 140. For example, the graph engagement data 140 may include a count 143a of the engagement edges 144a. For example, the count 143a may specify the number of engagement edges 144a. The count 143a may specify the number of engagement edges 144a originating from the user account 141a (e.g., the viewer’s side). In the example of FIG. 1G, the count 143a is six. The graph engagement data 140 may include a count 143b of the engagement edges 144b. For example, the count 143b may specify the number of engagement edges 144b. The count 143a may specify the number of engagement edges 144b ending in the author’s side, e.g., the user account 141c. In the example of FIG. 1G, the count 143b is five. The graph engagement data 140 may include a count 143c of intermediate user accounts 144c that are connected to both the user account 141a and the user account 141c. The intermediate user accounts 144c is a subset of the intermediate user accounts 141b that include connections to both the viewer and the author. For example, if an intermediate user account 141b is connected to the user account 141a via an engagement edge 144a and connected to the user account 141c via an engagement edge 144b, that number is added to the count 143c. In some examples, the count 143c may represent the number of intersecting edges (e.g., edges intersecting from the left and right side of the engagement graph 133. In the example of FIG. 1G, the count 143c is four.

In some examples, the graph relationship engine 135 generates a relationship score 145 representing a strength of the indirect relationship 146. The relationship score 145 may be a numerical value that indicates the level of the indirect relationship 146, e.g., higher the numerical value, the greater the strength of the indirect relationship 146. In some examples, the relationship score 145 may be a numerical value The graph relationship engine 135 may generate the relationship score 145 based on the graph engagement data 140. In some examples, the graph relationship engine 135 may compute the relationship score 145 based on the count 143a, the count 143b, and the count 143c. In some examples, the graph relationship engine 135 may compute the relationship score 145 based on Eq. (1):

$$\text{Relationship} \text{score} = \frac{c o u n t 143 c}{\sqrt{\left(c o u n t 143 a ∗ c o u n t 143 b\right)}} \qquad \text{(1)}$$

Referring to FIG. 1H, the prediction manager 114 may use the graph engagement signals 122 to generate the ranked list 116. For example, as explained above, the prediction manager 114 receives the candidate subset 112 from the light ranking manager 110 and ranks the messages of the candidate subset 112 according to a plurality of signals 118 to generate a ranked list 116, where the signals 118 may include the graph engagement signals 122. In some examples, the graph engagement signals 122 that are used for ranking the messages of the candidate subset 112 include one or more pieces of information as described with reference to FIG. 1F. In some examples, the graph engagement signal 122 includes information about the indirect relationship 146 (e.g., the type of indirect relationship). In some examples, the graph engagement signal 122 includes the relationship score 145. In some examples, the graph engagement signal 122 includes the graph engagement data 140, e.g., the count 143a, the count 143b, and/or the count 143c.

The prediction manager 114 may up rank a message in the conversation graph 126 that is authored by the user account 141c that has an indirect relationship 146 (e.g., a second-order relationship) with the user account 141a. The prediction manager 114 may increase the engagement value 123 associated with a message having an author with an indirect relationship 146 with the viewer (e.g., user account 141a). In some examples, the amount of the engagement value 123 being increased is dependent upon the type of indirect relationship 146. For example, if the indirect relationship 146 is a follow-to-favoritize relationship, the prediction manager 114 may increase the engagement value 123 by a first amount, but if the indirect relationship 146 is a mutual follow-to-mutual follow, the prediction manager 114 may increase the engagement value 123 by a second amount, where the first amount is greater than the second amount. In some examples, the amount of the engagement value 123 being increased is dependent upon the relationship score 145. For example, if the relationship score 145 is a higher value, the prediction manager 114 may increase the engagement value 123 by a greater amount (as compared with a relationship score 145 having a lower value). The engagement value 123 having a greater value may cause the message to be displayed before other messages having lower values.

Referring to FIG. 1I, the social context engine 120 may determine and select a particular social context object 124 for a message to be rendered on the display, where the social context object 124 includes information about the indirect relationship between the message’s author and the user account 141a. For example, suppose the user account 141a follows a number of intermediate user accounts 141b and those intermediate user accounts 141b have favoritorized or liked messages authored by the user account 141c. If a particular message from the user account 141c is on the ranked list 116 to be displayed to the user account 141a, the social context engine 120 may transmit information to insert a social context object 124 that may state “People you [the user account 141a] follow usually like Tristan’s [the user account 141c] messages” when the particular message is displayed. However, the type of social context object 124 is dependent upon the type of the indirect relationship 146. For example, if the user account 141a has favoritized or liked messages posted by intermediate user accounts 141b and the intermediate user accounts 141b have favoritized or liked messages posted by the user account 141c, the social context object 124 may state “Some accounts you like often like Tristan’s messages.”

The social context engine 120 may obtain graph engagement signals 122 (generated from the engagement graph(s) 133) for messages to be rendered as part of a response to a conversation view request 121. An engagement signal 122 used within the social context engine 120 may include one or more pieces of information explained with reference to FIG. 1F. In some examples, the graph engagement signal 122 includes information about the indirect relationship 146 (e.g., the type of indirect relationship). In some examples, the graph engagement signal 122 includes the relationship score 145. In some examples, the graph engagement signal 122 includes the graph engagement data 140, e.g., the count 143a, the count 143b, and/or the count 143c.

The social context engine 120 may use the indirect relationship 146, the graph engagement data 140, and/or the relationship score 145 to determine whether to insert a social context object 124, and, if so, determine which type of social context object 124 to insert. In some examples, the social context object 124 is inserted within the message when the message is displayed on the client application 154. In some examples, the social context object 124 is inserted into the stream of messages that are returned in response to the conversation view request 121 in an area that is proximate to (e.g., within a threshold distance) the corresponding message. In some examples, if the stream of messages include an order of message C, message D, and message E, the social context object 124 is inserted in the display at a location between message C and message E.

The social context engine 120 may include an initial eligibility criteria unit 147 that determines whether to insert the social context object 124 for a particular message based on initial eligibility criteria 148. The initial eligibility criteria 148 may define one or more initial conditions to render a social context object 124. In some examples, the initial eligibility criteria 148 indicates that the viewer (e.g., user account 141a) is not connected to the author (e.g., user account 141c) in the connection graph 126. In some examples, the initial eligibility criteria 148 indicates that the count 143a is equal to or greater than a threshold level. In some examples, the initial eligibility criteria unit 147 that the message is eligible to be a candidate for a social context object 124 in response to the user account 141a not being connected to the user account 141c in the connection graph and/or the number of engagement edges 144a is greater or equal to a threshold level (e.g., five, ten, twenty, etc.). If the message is not eligible to be a candidate (No), the initial eligibility criteria unit 147 may determine to not insert a social context object 124. If the message is eligible to be a candidate (Yes), the social context engine 120 uses other information from the graph engagement signal 122 to determine whether to render a social context object 124.

The social context engine 120 may include a relationship identifier 149 that identifies the type of indirect relationship 146. In some examples, the type of indirect relationship 146 is included in the graph engagement signal 122. In some examples, the graph engagement signal 122 includes the edge connection type 198a and the edge connection type 198b, and the relationship identifier 149 may identify the indirect relationship 146 based on the edge connection type 198a and the edge connection type 198b. For example, if the edge connection type 198a is a follow relationship and the edge connection type 198b is a follow relationship, the type of indirect relationship 146 is follower-to-follower relationship.

The social context engine 120 may select a threshold value 157 based on the type of indirect relationship 146 and determine to render the social context object 124 for a particular message in response to the relationship score 145 being equal to or greater than the threshold value 157. Then, the social context engine 120 may determine the information to be rendered in the social context object 124 based on the type of indirect relationship 146. The social context engine 120 may transmit information to the client application 154 to render the social context object 124 when the corresponding message is displayed on the client application 154.

The social context engine 120 may include a threshold selector 155 that selects a threshold value 157 based on the type of indirect relationship 146. For example, different types of indirect relationships 146 may be associated with different threshold values 157. As shown in FIG. 1J, the indirect relationships 146 may include an indirect relationship 146a, an indirect relationship 146b, and an indirect relationship 146c. Although three indirect relationships 146 are depicted in FIG. 1J, the types of indirect relationships 146 may be greater than three. Each indirect relationship 146 may be associated with a different threshold value 157. For example, the indirect relationship 146 may be associated with a threshold value 157a, the indirect relationship 146b may be associated with a threshold value 157b, and the indirect relationship 146c may be associated with a threshold value 157c, where the threshold value 157a, the threshold value 157b, and the threshold value 157c are different numerical values. If the indirect relationship 146 is determined as the indirect relationship 146a, the threshold selector 155 may select the threshold value 157a.

Referring back to FIG. 1I, the social context engine 120 includes an eligibility unit 153 configured to compare the relationship score 145 with the threshold value 157 selected by the threshold selector 155. If the relationship score 145 is equal to or greater than the threshold value 157 (Yes), an object selector 158 of the social context engine 120 may identify a social context object 124 to be inserted within (or for) a particular message based on the type of indirect relationship 146. For example, different indirect relationships 146 are associated with different social context objects 124. As shown in FIG. 1J, the indirect relationship 146a is associated with a social context object 124a, the indirect relationship 146b is associated with a social context object 124b, and the indirect relationship 146c is associated with a social context object 124c. If the type of indirect relationship 146 is the indirect relationship 146b, the object selector 158 may select the social context object 124b to be inserted on the display for a particular message.

In some examples, different social context objects 124 have a different text that explains the indirect relationship 146 (e.g., “People you follow usually like Tristan’s messages”, “Some Accounts you like often like Tristan’s messages”, “Some Accounts you like often follow Tristan”, “Some Accounts you like often mention Tristan”, “Some Accounts you like often reshare Tristan’s messages”, etc.). In some examples, different social context objects 124 may have different UI icons and/or shapes. For example, the social context object 124b may have a UI icon and/or shape that is different (and/or addition to) the UI icon(s) and/or shapes of the social context object 124a.

In some examples, the social context engine 120 defines priority order information 179 that defines a priority order of indirect relationships 146. For example, the priority order information 179 may assign different priority levels to different indirect relationships 146, e.g., indirect relationship 146a has a higher priority level than indirect relationship 146b, which has a higher priority level than indirect relationship 146a. A viewer (e.g., user account 141a) may have multiple indirect relationships 146 with an author (e.g., user account 141c). For example, the user account 141a may have an indirect relationship 146a with the user account 141c, and the user account 141a may also have an indirect relationship 146b with the user account 141c. The social context engine 120 may select one of the indirect relationship 146a or the indirect relationship 146b based on the priority order information 179 to evaluate whether a social context object 124 would be inserted with respect to a message from an author having an indirect relationship 146 with a viewer. For example, if the indirect relationship 146a has a priority level higher than the priority level associated with the indirect relationship 146b, the relationship identifier 149 may select the indirect relationship 146a, which causes the threshold value 157a to be selected.

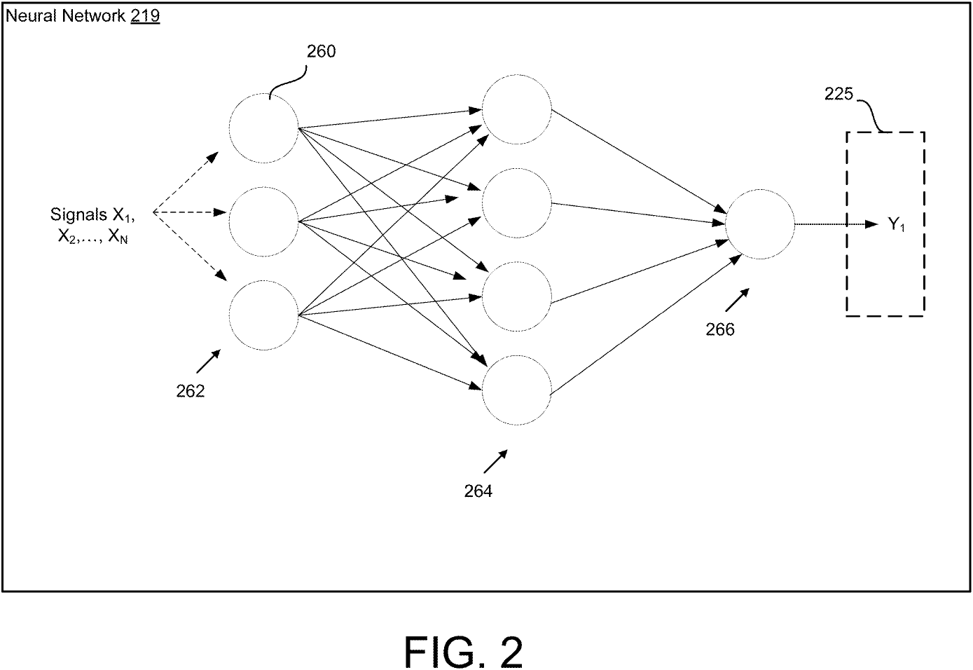

FIG. 2 illustrates a neural network 219 according to an aspect. The neural network 219 may be an example of a predictive model 117. The neural network 219 is configured to output a predictive outcome 225. The neural network 219 may be an interconnected group of nodes 260, where each node 260 represents an artificial neuron. The nodes 260 are connected to each other in layers, with the output of one layer becoming the input of a next layer. The neural network 219 transforms an input X₁, X₂ through X_{N} (e.g., the signals 118), received by an input layer 262, transforms it through one or more hidden layers 264 (e.g., FIG. 2 illustrates one hidden layer 264), and produces an output Y₁ (e.g. the predictive outcome(s) 225) via an output layer 266. Each layer is made up of a subset of the set of nodes 260.

Using the neural network 219 to obtain the predictive outcome(s) 225 may involve applying weighted and biased numeric input to interconnected nodes 260 in the neural network 219 and computing their output. The weights and bias applied to each node 260 in the neural network 219 may be obtained by training the neural network 219 using, for example, machine learning algorithms. The nodes 260 in the neural network 219 may be organized in two or more layers including at least the input layer 262 and the output layer 266. For a multi-layered neural network 219, the output from one layer may serve as input to the next layer. The layers with no external output connections may be referred to as the hidden layers 264. The output of each node 260 is a function of the weighted sum of its inputs plus a bias.

To obtain the predictive outcome(s) 225, a vector of feature values (X₁...X_{N}) is applied as the input to each node 260 in the input layer 262. In some examples, the vector of feature values (X₁...X_{N}) includes the values of the signals 118 explained above. The input layer 262 distributes the values to each of the nodes 260 in the hidden layer 264. Arriving at a node 260 in the hidden layer 264, the value from each input node is multiplied by a weight, and the resulting weighted values are summed together and added to a weighted bias value producing a combined value. The combined value is passed through a transfer or activation function, which outputs a value. Next, the outputs from the hidden layer 264 are distributed to the node 260 in the output layer 266 of the neural network 219. Arriving at a node 260 in the output layer 266, the value from each hidden layer node is multiplied by a weight, and the resulting weighted values are summed together and added to a weighted bias value to produce a combined value. The combined value is passed through the transfer or activation function, which outputs Y₁ (e.g., the predictive outcome(s) 225).

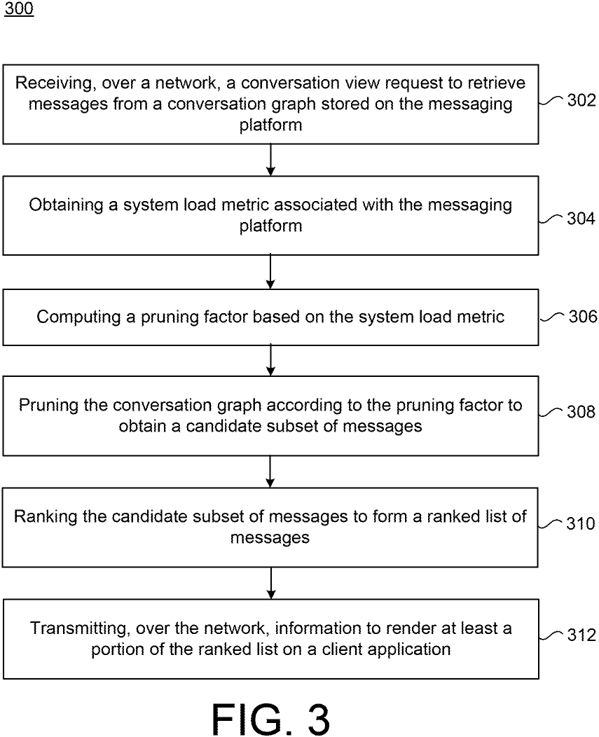

FIG. 3 is a flowchart 300 depicting example operations of a messaging platform for ranking messaging of a conversation graph according to an aspect. Although the flowchart 300 is explained with respect to the messaging system of FIGS. 1A through 1J, the flowchart 300 may be applicable to any of the embodiments discussed herein. Although the flowchart 300 of FIG. 3 illustrates the operations in sequential order, it will be appreciated that this is merely an example, and that additional or alternative operations may be included. Further, operations of FIG. 3 and related operations may be executed in a different order than that shown, or in a parallel or overlapping fashion.

Operation 302 includes receiving, over a network 150, a conversation view request 121 to retrieve messages from a conversation graph 126 stored on the messaging platform 104. Operation 304 includes obtaining a system load metric 167 associated with the messaging platform 104. Operation 306 includes computing a pruning factor 178 based on the system load metric 167. Operation 308 includes pruning the conversation graph 126 according to the pruning factor 178 to obtain a candidate subset 112 of messages. Operation 310 includes ranking the candidate subset 112 of messages to form a ranked list 116 of messages. Operation 312 includes transmitting, over the network 150, information to render at least a portion of the ranked list 116 on a client application 154.

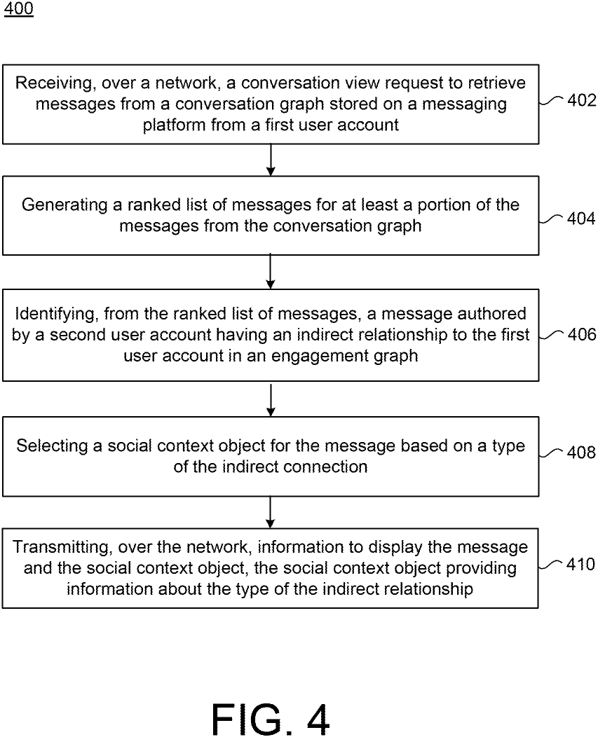

FIG. 4 is a flowchart 400 depicting example operations of a messaging platform according to an aspect. Although the flowchart 400 is explained with respect to the messaging system of FIGS. 1A through 1J, the flowchart 400 may be applicable to any of the embodiments discussed herein. Although the flowchart 400 of FIG. 4 illustrates the operations in sequential order, it will be appreciated that this is merely an example, and that additional or alternative operations may be included. Further, operations of FIG. 4 and related operations may be executed in a different order than that shown, or in a parallel or overlapping fashion.

Operation 402 includes receiving, over a network 150, a conversation view request 121 to retrieve messages from a conversation graph 126 stored on a messaging platform 104 from a first user account (e.g., user account 141a). Operation 404 includes generating a ranked list 116 of messages for at least a portion of the messages from the conversation graph 126. Operation 406 includes identifying, from the ranked list 116 of messages, a message authored by a second user account (e.g., user account 141c) having an indirect relationship 146 to the first user account (e.g., user account 141a) in an engagement graph 133. Operation 408 includes selecting a social context object 124 for the message based on a type of the indirect relationship 146. Operation 410 includes transmitting, over the network 150, information to display the message and the social context object 124, the social context object 124 providing information about the type of the indirect relationship 146.

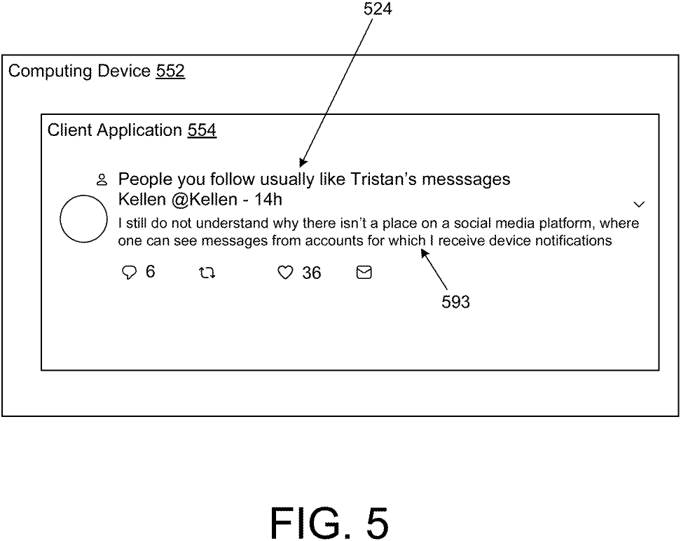

FIG. 5 illustrates an example of a social context object 524 displayed with reference to a message 593 on a client application 554 of a computing device 552. The message 593 may be rendered in response to a conversation view request, a search on the messaging platform, or other sections of the client application 554 that may display messages from user accounts that are not connected to the user account of the client application 554 in a connection graph. The social context object 524 may provide information about the indirect relationship between the viewer and the author. In some examples, the social context object 524 is rendered at a location above a user identifier associated with the display message. In some examples, the social context object 524 includes one or more UI icons.

In the above description, numerous details are set forth. It will be apparent, however, to one of ordinary skill in the art having the benefit of this disclosure, that implementations of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “determining,” “calculating,” “updating,” “transmitting,” “receiving,” “generating,” “changing,” or the like, refer to the actions and processes of a computer system, or similar electronic computing device, that manipulates and transforms data represented as physical (e.g., electronic) quantities within the computer system’s registers and memories into other data similarly represented as physical quantities within the computer system memories or registers or other such information storage, transmission or display devices.

Implementations of the disclosure also relate to an apparatus for performing the operations herein. This apparatus may be specially constructed for the required purposes, or it may include a general-purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several implementations of the present disclosure. It will be apparent to one skilled in the art, however, that at least some implementations of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

What is claimed is:

1. A method comprising:
receiving, over a network from a first user account, a conversation view request to retrieve messages from a conversation graph stored on a messaging platform;
generating a ranked list of messages for at least a portion of the messages from the conversation graph;
identifying, from the ranked list of messages, a message authored by a second user account, the second user account having an indirect relationship to the first user account in an engagement graph, wherein the engagement graph defines relationships between user accounts of the messaging platform;
selecting a social context object for the message based on a type of the indirect relationship; and
transmitting, over the network, information to display the message and the social context object, the social context object providing information about the type of the indirect relationship.

2. The method of claim 1, wherein the engagement graph includes a first engagement edge connected to the first user account and an intermediate user account and a second engagement edge connected to the intermediate user account and the second user account, the method further comprising:
determining the type of the indirect relationship based on information about the first engagement edge and information about the second engagement edge.

3. The method of claim 2, wherein the information about the first engagement edge indicates that the first user account is connected to the intermediate user account in a connection graph of the messaging platform, and the information about the second engagement edge indicates that the intermediate user account has engaged with one or more messages authored by the second user account.

4. The method of claim 1, wherein the indirect relationship includes a second-order engagement relationship between the first user account and the second user account.

5. The method of claim 1, further comprising:
computing a relationship score for a strength of the indirect relationship; and
determining, in response to the relationship score being greater than a threshold, whether to display the social context object.

6. The method of claim 5, wherein computing the relationship score includes:
determining a first count of first engagement edges between the first user account and a plurality of intermediate user accounts;
determining a second count of second engagement edges between the plurality of intermediate user accounts and the second user account;
determining a third count of the plurality of intermediate user accounts that are connected to both the first user account and the second user account; and
computing the relationship score based on the first count, the second count, and the third count.

7. The method of claim 5, further comprising:
selecting a value for the threshold based on the type of indirect relationship.

8. The method of claim 1, wherein the indirect relationship is a first indirect relationship, the method further comprising:
identifying a second indirect relationship between the second user account and the first user account; and
determining that the first indirect relationship has a priority level higher than a priority level of the second indirect relationship based on priority order information,
wherein the social context object is selected based on the type of the first indirect relationship.

9. The method of claim 1, wherein generating the ranked list of messages includes:
computing an engagement value for each of a plurality of messages of the conversation graph; and
increasing the engagement value in response to a respective message having a user account with an indirect relationship to the first user account in the engagement graph.

10. A messaging system comprising:
at least one processor; and
a non-transitory computer-readable medium storing executable instructions that when executed by the at least one processor cause the at least one processor to:
receive, over a network from a first user account, a conversation view request to retrieve messages from a conversation graph stored on a messaging platform;
generate a ranked list of messages for at least a portion of the messages from the conversation graph;
identify, from the ranked list of messages, a message authored by a second user account, the second user account having an indirect relationship to the first user account in an engagement graph, wherein the engagement graph defines relationships between user accounts of the messaging platform;
select a social context object for the message based on a type of the indirect relationship;
transmit, over the network, information to display at least a portion of the ranked list of messages on a client application; and
transmit, over the network, information to display the social context object along with the message on the client application, the social context object providing information about the type of the indirect relationship.

11. The messaging system of claim 10, wherein the engagement graph includes a first engagement edge connected to the first user account and an intermediate user account and a second engagement edge connected to the intermediate user account and the second user account, wherein the executable instructions include instructions that when executed by the at least one processor cause the at least one processor to:
determine the type of the indirect relationship based on information about the first engagement edge and information about the second engagement edge.

12. The messaging system of claim 10, wherein the indirect relationship includes a second-order engagement relationship between the first user account and the second user account.

13. The messaging system of claim 10, wherein the executable instructions include instructions that when executed by the at least one processor cause the at least one processor to:
compute a relationship score for a strength of the indirect relationship; and
determine, in response to the relationship score being greater than a threshold, whether to display the social context object.

14. The messaging system of claim 13, wherein the executable instructions include instructions that when executed by the at least one processor cause the at least one processor to:
determine a first count of first engagement edges between the first user account and a plurality of intermediate user accounts;
determine a second count of second engagement edges between the plurality of intermediate user accounts and the second user account;
determine a third count of the plurality of intermediate user accounts that are connected to both the first user account and the second user account; and
compute the relationship score based on the first count, the second count, and the third count.

15. The messaging system of claim 14, wherein the executable instructions include instructions that when executed by the at least one processor cause the at least one processor to:
select a value for the threshold based on the type of the indirect relationship.

16. The messaging system of claim 10, wherein the indirect relationship is a first indirect relationship, wherein the executable instructions include instructions that when executed by the at least one processor cause the at least one processor to:
identify a second indirect relationship between the second user account and the first user account; and
determine that the first indirect relationship has a priority level higher than a priority level of the second indirect relationship based on priority order information,
wherein the social context object is selected based on the type of the first indirect relationship.

17. A non-transitory computer-readable medium storing executable instructions that when executed by at least one processor cause the at least one processor to execute operations, the operations comprising:
receiving, over a network from a first user account, a conversation view request to retrieve messages from a conversation graph stored on a messaging platform;
generating a ranked list of messages for at least a portion of the messages from the conversation graph;
identifying, from the ranked list of messages, a message authored by a second user account, the second user account having an indirect relationship to the first user account in an engagement graph, wherein the engagement graph defines relationships between user accounts of the messaging platform;
selecting a social context object for the message based on a type of the indirect relationship;
transmitting, over the network, information to display at least a portion of the ranked list of messages on a client application; and
transmitting, over the network, information to display the social context object along with the message on the client application, the social context object providing information about the type of the indirect relationship.

18. The non-transitory computer-readable medium of claim 17, wherein the operations further comprise:
computing an engagement value for each of a plurality of messages of the conversation graph; and
increasing the engagement value in response to a respective message having a user account with an indirect relationship to the first user account in the engagement graph.

19. The non-transitory computer-readable medium of claim 17, wherein the operations further comprise:
computing a relationship score for a strength of the indirect relationship; and
determining, in response to the relationship score being greater than a threshold, whether to display the social context object.

20. The non-transitory computer-readable medium of claim 19, wherein the operations further comprise:
determining a first count of first engagement edges between the first user account and a plurality of intermediate user accounts;
determining a second count of second engagement edges between the plurality of intermediate user accounts and the second user account;
determining a third count of the plurality of intermediate user accounts that are connected to both the first user account and the second user account; and
computing the relationship score based on the first count, the second count, and the third count.
